(19) United States
(12) Patent Application Publication
(10) Pub. No.: US 2026/0205963 A1
(43) Pub. Date: Jul. 16, 2026

(54) POWER CONTROL ASSOCIATED WITH A SENSING TRANSCEIVER

(71) Applicant: QUALCOMM Incorporated, San Diego, CA (US)

(72) Inventors: Preeti KUMARI, San Diego, CA (US); Kapil GULATI, Belle Mead, NJ (US); Junyi LI, Greentown, PA (US); Stelios STEFANATOS, San Diego, CA (US); Shijun WU, San Diego, CA (US)

(21) Appl. No.: 19/127,910

(22) PCT Filed: Jan. 3, 2024
(86) PCT No.: PCT/US2024/010131

§ 371 Date: May 7, 2025

(30) Foreign Application Priority Data
Jan. 4, 2023 (GR) 20230100003

(51) Int. Cl. H04W 52/36; H04L 5/00; H04W 52/24; H04W 52/34

(52) U.S. Cl. CPC H04W 52/367; H04L 5/0051; H04W 52/24; H04W 52/343

(57) ABSTRACT

A user equipment receives configuration data, including an indication of at least one of: sensing resources, or a sensing resource pool from a network entity. The user equipment transmits a sensing waveform configured according to the at least one of: the sensing resources, or the sensing resource pool and receives a reflection of the sensing waveform from a target. The user equipment transmits a recommended power level for subsequent transmissions to a network entity based on the reflection of the sensing waveform received at the user equipment from the target. A network entity transmits configuration data, including the indication of the at least one of: the sensing resources, or the sensing resource pool, and receives, from the user equipment, the recommended power level, which was based on the reflection of the sensing waveform received at the user equipment.

### CROSS-REFERENCE TO RELATED APPLICATIONS

The present application for patent claims priority to pending Greek Application no. 20230100003, filed Jan. 4, 2023, and assigned to the assignee hereof and hereby expressly incorporated by reference herein as if fully set forth below and for all applicable purposes.

### TECHNICAL FIELD

The technology discussed below relates generally to wireless communication networks and, more particularly, to power control associated with a sensing transceiver. The sensing transceiver may implement a monostatic radar-type process and utilize uplink resources for communication and radar processes.

### INTRODUCTION

In wireless communication systems, such as those specified under 5G New Radio (NR) standards, a user equipment (UE) may be configured with resources by a network entity. The UE may be integrated into a vehicle or otherwise incorporated into the vehicle. The use of a UE for vehicle-to-vehicle, vehicle-to-infrastructure, collision avoidance, and other vehicular-related aspects presents designers of UEs, including UEs integrated into a vehicle or otherwise incorporated into the vehicle with opportunities to improve the lives and the safety of users. Operability of UEs within a network in ways that may avoid contributing to congestion within the network may be considered.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a user equipment (UE) is disclosed. The UE includes a transceiver, a memory, and a processor coupled to the transceiver and the memory. In the example, the processor being configured to: receive configuration data, including at least one of: sensing resources, or a sensing resource pool, transmit a sensing waveform configured according to the at least one of: the sensing resources, or the sensing resource pool, and transmit a recommended power level based on a reflection of the sensing waveform received at the UE from a target.

In another example a method at a user equipment (UE) is disclosed. the method includes receiving configuration data, including at least one of: sensing resources, or a sensing resource pool, transmitting a sensing waveform configured according to the at least one of: the sensing resources, or the sensing resource pool, and transmitting a recommended power level based on a reflection of the sensing waveform received at the UE from a target.

In still another example a network entity is disclosed. The network entity includes a memory, and a processor coupled to the memory. In the example, the processor is configured to: transmit configuration data, including at least one of: sensing resources, or a sensing resource pool, and receive a recommended power level based on a reflection of a sensing waveform received at a user equipment (UE) from a target.

In another example a method at a network entity is disclosed. The method includes transmitting configuration data, including at least one of: sensing resources, or a sensing resource pool, and receiving a recommended power level based on a reflection of a sensing waveform received at a user equipment (UE) from a target.

These and other aspects of the disclosure will become more fully understood upon a review of the detailed description, which follows. Other aspects, features, and examples of the present disclosure will become apparent to those of ordinary skill in the art, upon reviewing the following description of specific, examples of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In a similar fashion, while any example may be discussed below in connection with a device, system, or method, it should be understood that such examples can be implemented in various devices, systems, and methods.

### BRIEF DESCRIPTION OF THE DRAWINGS

FIG. 1 is a schematic illustration of a wireless communication system according to some aspects of the disclosure.

FIG. 2 is a schematic illustration of an example of a radio access network (RAN) according to some aspects of the disclosure.

FIG. 3 is a schematic illustration of an example of a disaggregated base station architecture according to some aspects of the disclosure.

FIG. 4 illustrates an example of a wireless communication network configured to support device-to-device or sidelink communication according to some aspects of the disclosure.

FIG. 5 is an expanded view of an exemplary subframe, showing an orthogonal frequency divisional multiplexing (OFDM) resource grid according to some aspects of the disclosure.

FIGS. 6A and 6B are block diagrams depicting a cooperative joint communication and radio detection and ranging (radar) (JCR) system and a co-designed JCR system, respectively, according to some aspects of the disclosure.

FIGS. 7A and 7B are block diagrams depicting a monostatic radar process/configuration and a bistatic radar process/configuration, respectively, according to some aspects of the disclosure.

FIGS. 8A and 8B are plots of antenna beam patterns for single-stage uplink sensing and two-stage uplink sensing, respectively, according to some aspects of the disclosure.

FIG. 9 is a diagram illustrating an example of a sensing resource pool in one slot according to some aspects of the disclosure.

FIG. 10 is a block diagram illustrating an example of a hardware implementation of a user equipment employing a processing system, according to some aspects of the disclosure.

FIG. 11 is a flow chart illustrating an example process at a user equipment, according to some aspects of the disclosure.

FIG. 12 is a block diagram illustrating an example of a hardware implementation of a network entity employing a processing system, according to some aspects of the disclosure.

FIG. 13 is a flow chart illustrating an example process at a network entity, according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some examples, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or user equipment (UE)), end-user devices, etc. of varying sizes, shapes, and constitution.

Described herein are techniques associated with the use of a joint communication and radar (JCR) transceiver, utilizing a monostatic configuration, in a two-stage uplink sensing application, according to some aspects of the disclosure.

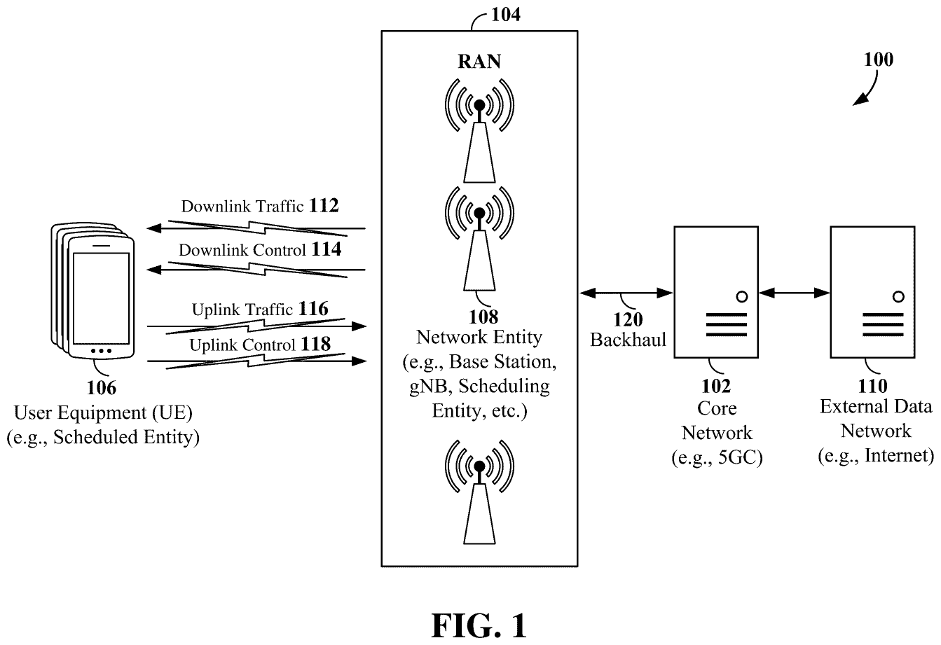

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 (also referred to herein as a wireless communication device) may be enabled to carry out data communication with an external data network, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of network entities 108. Broadly, a network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some examples, a network entity may be a network element in a radio access network responsible for radio transmission and reception in one or more cells to or from a UE. In different technologies, standards, or contexts, a network entity may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a network entity may include two or more TRPs that may be collocated or non-collocated. Each TRP may communicate on the same or different carrier frequency within the same or different frequency band. In examples where the RAN 104 operates according to both the LTE and 5G NR standards, one of the network entities may be an LTE network entity, while another network entity may be a 5G NR network entity.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus, a wireless communication device) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF-chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a network entity (e.g., similar to network entity 108) to one or more UEs (e.g., similar to UE 106) may be referred to as downlink (DL) transmission. In accordance with certain aspects of the present disclosure, the term downlink may refer to a point-to-multipoint transmission or a point-to-point transmission (e.g., groupcast, multicast, or unicast) originating at a network entity (e.g., network entity 108). Another way to describe this scheme may be to use the term broadcast channel multiplexing. Transmissions from a UE (e.g., UE 106) to a network entity (e.g., network entity 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, where a network entity (e.g., a network entity 108) allocates resources for communication among some or all devices and equipment within its service area or cell. Within the present disclosure, as discussed further below, the network entity (e.g., network entity 108) may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the network entity 108.

Network entities 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, the network entity 108 may broadcast downlink traffic 112 (also referred to as downlink data traffic) to one or more UEs 106. Broadly, the network entity 108 may be a node or device responsible for scheduling traffic (e.g., data traffic, user data traffic) in a wireless communication network, including the downlink traffic 112 and, in some examples, uplink traffic 116 (also referred to as uplink data traffic) from one or more UEs 106 to the network entity 108. On the other hand, the UE 106 (e.g., the scheduled entity) may be a node or device that receives downlink control information 114, including but not limited to scheduling information (e.g., a grant), synchronization or timing information, or other control information from another entity in the wireless communication network such as the network entity 108. The UE 106 may further transmit uplink control information 118, including but not limited to a scheduling request or feedback information, or other control information to the network entity 108.

In addition, the uplink control information 118 and/or downlink control information 114 and/or uplink traffic 116 and/or downlink traffic 112 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per subcarrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, the network entity 108 may include a backhaul interface (not shown) for communication with a backhaul portion 120 of the wireless communication system 100. The backhaul portion 120 may provide a link between a network entity 108 and the core network 102. Further, in some examples, a backhaul network may provide interconnection between respective network entities 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5G core (5GC)). In other examples, the core network 102 may be configured according to a 4G evolved packet core (EPC), or any other suitable standard or configuration.

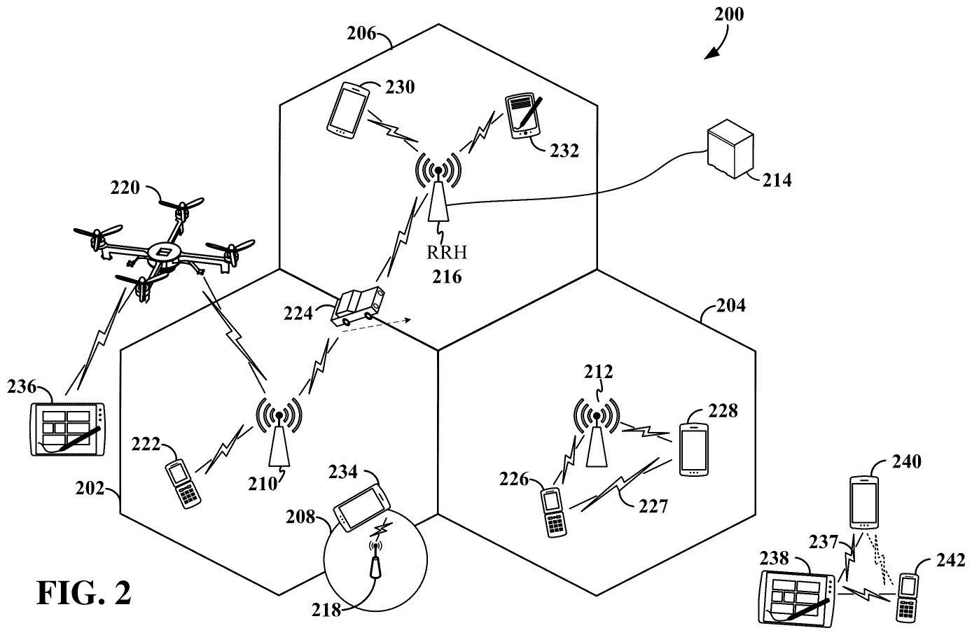

Referring now to FIG. 2, as an illustrative example without limitation, a schematic illustration of an example of a radio access network (RAN) 200 according to some aspects of the disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or network entity. FIG. 2 illustrates cells 202, 204, 206, and 208, each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various network entity arrangements can be utilized. For example, in FIG. 2, two network entities, referred to as base station 210 and base station 212, are shown in cells 202 and 204. A third network entity, referred to as base station 214, is shown controlling a remote radio head (RRH) 216 in cell 206. That is, a network entity can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a small cell, a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of network entities (e.g., base stations, gNBs, TRPs, scheduling entities) and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the network entity 108 described above and illustrated in FIG. 1.

FIG. 2 further includes an unmanned aerial vehicle (UAV) 220, which may be a drone, quadcopter, octocopter, etc. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210, UEs 226 and 228 may be in communication with base station 212, UEs 230 and 232 may be in communication with base station 214 by way of RRH 216, UE 234 may be in communication with base station 218, and UE 236 may be in communication with mobile base station 220. In some examples, the UEs 222, 224, 226, 228, 230, 232, 234, 236, 238, 240, and/or 242 may be the same as or similar to the one or more UEs 106 described above and illustrated in FIG. 1. In some examples, the UAV 220 may be a mobile network entity and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station (e.g., a network entity). In other examples, two or more UEs (e.g., UEs 226 and 228) within the coverage area of a network entity (e.g., base station 212) may also communicate sidelink signals 227 over a direct link (sidelink) without conveying that communication through the network entity (e.g., base station 212). In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of network entities and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a network entity (e.g., an aggregated or disaggregated base station, gNB, eNB, TRP, scheduling entity, etc.), or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell (e.g., cell 202) to the geographic area corresponding to a neighbor cell (e.g., cell 206). When the signal strength or quality from the neighbor cell exceeds that of its serving cell for a given amount of time, the UE 224 may transmit a reporting message to its serving network entity (e.g., base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, where technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into the mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different subbands of the carrier bandwidth. This type of full-duplex communication may be referred to herein as subband full-duplex (SBFD), also known as flexible duplex.

Deployment of communication systems, such as 5G new radio (NR) systems, may be arranged in multiple manners with various components or constituent parts. In a 5G NR system, or network, a network entity, a network entity, a mobility element of a network, a radio access network (RAN) node, a core network entity, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

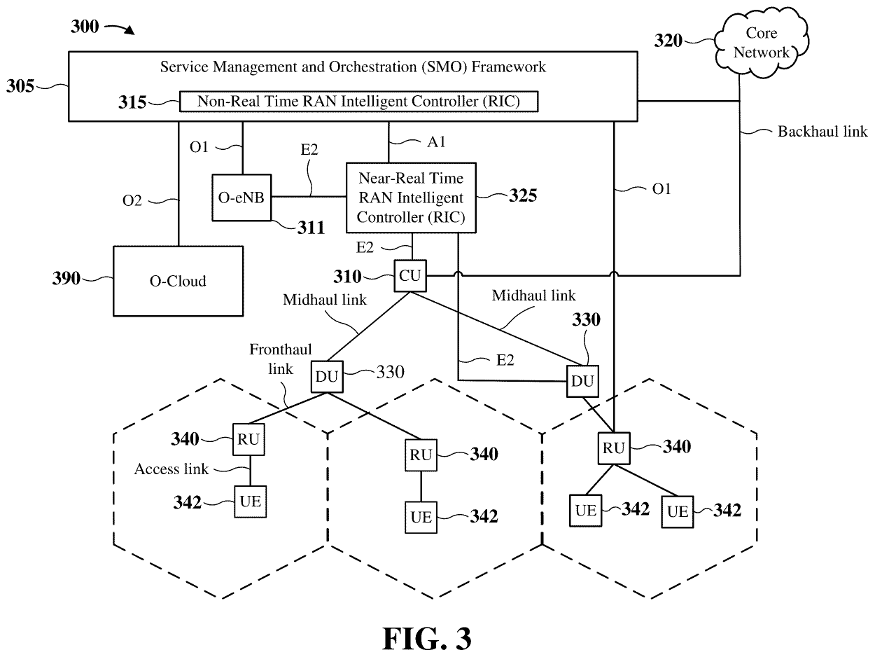

FIG. 3 is a schematic illustration of an example disaggregated base station 300 architecture according to some aspects of the disclosure. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 342 via one or more radio frequency (RF) access links. In some implementations, the UE 342 may be simultaneously served by multiple RUs 340. UE 342 may be the same or similar to any of the UEs or scheduled entities illustrated and described in connection with FIG. 1 and FIG. 2, for example.

Each of the units, i.e., the CUs 310, the DUs 330, the RUs 340, as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation, and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 342. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 3G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as AI policies).

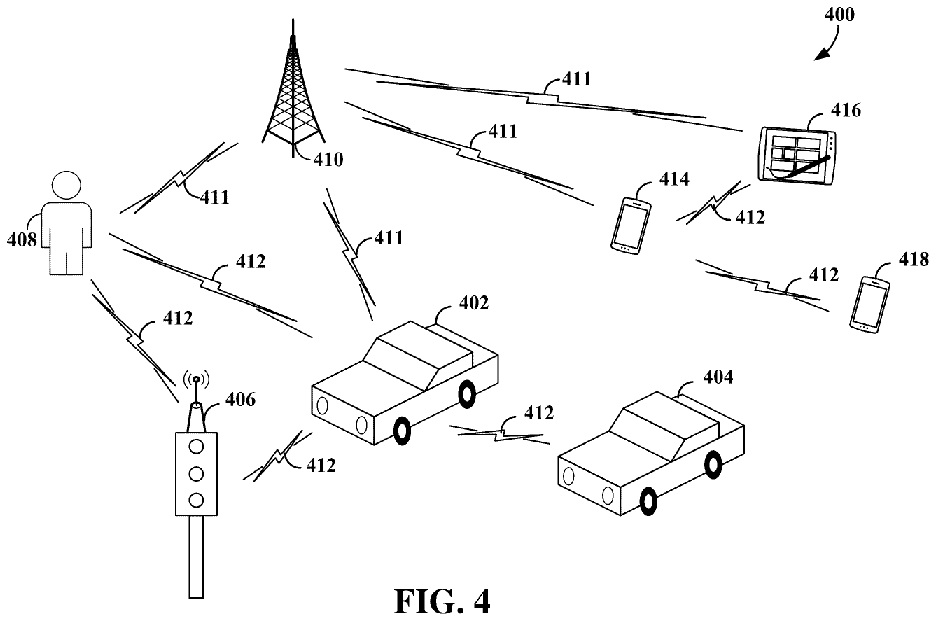

FIG. 4 illustrates an example of a wireless communication network 400 configured to support device-to-device (D2D) or sidelink communication according to some aspects of the disclosure. In some examples, sidelink communication may include V2X communication. V2X communication involves the wireless exchange of information directly between not only vehicles (e.g., vehicles 402 and 404) themselves but also directly between vehicles 402 and 404 and infrastructure (e.g., roadside unit (RSU) 406), such as streetlights, buildings, traffic cameras, tollbooths or other stationary objects, vehicles 402 and 404 and pedestrian 408 (or pedestrian/cyclist), and vehicles 402 and 404 and wireless communication networks (e.g., network entity 410). The network entity 410 may be, for example, any base station (e.g., gNB, eNB) or other scheduling entity as illustrated in FIG. 1. The network entity 410 may further be implemented in an aggregated or monolithic base station architecture or a disaggregated base station architecture. In addition, the network entity 410 may be a stationary network entity or a mobile network entity. In some examples, V2X communication may be implemented in accordance with the New Radio (NR) cellular V2X standard defined by 4GPP, Release 16, or other suitable standards.

V2X communication enables vehicles 402 and 404 to obtain information related to the weather, nearby accidents, road conditions, activities of nearby vehicles and pedestrians, objects nearby the vehicle, and other pertinent information that may be utilized to improve the vehicle driving experience and increase vehicle safety. For example, such V2X data may enable autonomous driving and improve road safety and traffic efficiency. For example, the exchanged V2X data may be utilized by a V2X connected vehicle 402 and 404 to provide in-vehicle collision warnings, road hazard warnings, approaching emergency vehicle warnings, pre-/post-crash warnings and information, emergency brake warnings, traffic jam ahead warnings, lane change warnings, intelligent navigation services, and other similar information. In addition, V2X data received by a V2X connected mobile device of a pedestrian 408 may be utilized to trigger a warning sound, vibration, flashing light, etc., in case of imminent danger.

The sidelink communication between vehicle 402 and 404 (e.g., V-UEs) or between a vehicles 402 or 404 and either an RSU 406 or a pedestrian 408 (e.g., a pedestrian-UE (P-UE)) may occur over a sidelink 412 utilizing a proximity service (ProSe) PC5 interface. In various aspects of the disclosure, the PC5 interface may further be utilized to support D2D sidelink 412 communication in other proximity use cases. Examples of other proximity use cases may include public safety or commercial (e.g., entertainment, education, office, medical, and/or interactive) based proximity services. In the example shown in FIG. 2, ProSe communication may further occur between UEs 226 and 228.

ProSe communication may support different operational scenarios, such as in-coverage, out-of-coverage, and partial coverage. Out-of-coverage refers to a scenario in which UEs (e.g., UE 418 and V-UE 404) are outside of the coverage area of a network entity 410 (e.g., an aggregated or disaggregated base station, gNB, scheduling, etc.), but each are still configured for ProSe communication (e.g., via sidelink 412). Partial coverage refers to a scenario in which some of the UEs (e.g., UE 418 and V-UE 404) are outside of the coverage area of the network entity 410, while other devices (e.g., vehicle 402 (a V-UE), pedestrian 408 (e.g., a P-UE), UE 414, and UE 416) are in communication with the network entity 410. In-coverage refers to a scenario in which UEs (e.g., vehicle 402 (e.g., a V-UE), pedestrian 408 (e.g., a P-UE), UE 414, and UE 416) are in communication with the network entity 410 via a Uu wireless communication link (e.g., cellular interface 411) connection to receive ProSe service authorization and provisioning information to support ProSe operations.

In some examples, a UE (e.g., UE 418) may not have a Uu connection with the network entity 410. In this example, a D2D relay link (over sidelink 412) may be established between UE 418 and UE 414 to relay communication between the UE 418 and the network entity 410. The relay link may utilize decode and forward (DF) relaying, amplify and forward (AF) relaying, or compress and forward (CF) relaying. For DF relaying, HARQ feedback may be provided from the receiving device to the transmitting device. The sidelink communication over the relay link may be carried, for example, in a licensed frequency domain using radio resources operating according to a 5G NR or NR sidelink (SL) specification and/or in an unlicensed frequency domain, using radio resources operating according to 5G new radio-unlicensed (NR-U) specifications. NR-U operates in the 5 GHz and 6 GHz frequency bands and supports both standalone and licensed-assisted operation based on carrier aggregation and dual connectivity with either NR or LTE in the licensed spectrum. The relay link between UE 414 and UE 418 may be established due to, for example, distance or signal blocking between the network entity 410 and the UE 418, weak receiving capability of the UE 418, low transmission power of the UE 418, limited battery capacity of the UE 418, and/or to improve link diversity. Thus, the relay link may enable communication between the network entity 410 and UE 418 to be relayed via one or more relay UEs (e.g., UE 414) over a Uu wireless communication link (e.g., cellular interface 411) and relay link(s) (e.g., sidelink 412) between UE 414 and UE 418. In other examples, a relay link (e.g., sidelink 412) may enable sidelink communication to be relayed between a UE (e.g., UE 416) and another UE (e.g., UE 414) over various relay links (e.g., sidelink 412) in response to a loss of a Uu wireless communication link (e.g., cellular interface 411) between the UE (e.g., UE 416) and the network entity 410, for example.

To facilitate D2D sidelink communication between, for example, UEs 414 and 416 over the sidelink 412, the UEs 414 and 416 may transmit discovery signals therebetween. In some examples, each discovery signal may include a synchronization signal, such as a primary synchronization signal (PSS) and/or a secondary synchronization signal (SSS) that facilitates device discovery and enables synchronization of communication on the sidelink 412. For example, the discovery signal may be utilized by the UE 416 to measure the signal strength and channel status of a potential sidelink (e.g., sidelink 412) with another UE (e.g., UE 414). The UE 416 may utilize the measurement results to select a UE (e.g., UE 414) for sidelink communication or relay communication.

In some examples, a common carrier may be shared between the sidelinks 412 and Uu links 411, such that resources on the common carrier may be allocated for both sidelink communication between UEs (e.g., vehicles 402 and 404 (e.g., V-UEs), RSU 406 (e.g. in infrastructure UE), pedestrian 408 (e.g., a P-UE), 414, 416, and 418) and cellular communication (e.g., uplink and downlink communication) between the UEs (e.g., vehicles 402 and 404 (e.g., V-UEs), RSU 406 (e.g. in infrastructure UE), pedestrian 408 (e.g., a P-UE), 414, 416, and 418) and the network entity 410. In 5G NR sidelink, sidelink communication may utilize transmission or reception resource pools. For example, the minimum resource allocation unit in frequency may be a sub-channel (e.g., which may include, for example, 10, 15, 20, 25, 50, 75, or 100 consecutive resource blocks) and the minimum resource allocation unit in time may be one slot. The number of sub-channels in a resource pool may include between one and twenty-seven sub-channels. A radio resource control (RRC) configuration of the resource pools may be either pre-configured (e.g., a factory setting on the UE determined, for example, by sidelink standards or specifications) or configured by a network entity (e.g., network entity 410).

In addition, there may be two main resource allocation modes of operation for sidelink (e.g., PC5) communications. In a first mode, Mode 1, a network entity 410 may allocate resources to sidelink devices (e.g., V2X devices or other sidelink devices) for sidelink communication between the sidelink devices in various manners. For example, the network entity 410 may allocate sidelink resources dynamically (e.g., a dynamic grant) to sidelink devices, in response to requests for sidelink resources from the sidelink devices. For example, the network entity 410 may schedule the sidelink communication via DCI 4_0. In some examples, the network entity 410 may schedule a PSCCH/PSSCH within uplink resources indicated in DCI 4_0. The network entity 410 may further activate preconfigured sidelink grants (e.g., configured grants) for sidelink communication among the sidelink devices. In some examples, the network entity 410 may activate a configured grant (CG) via RRC signaling. In Mode 1, sidelink feedback may be reported back to the network entity 410 by a transmitting sidelink device.

In a second mode, Mode 2, the sidelink devices may autonomously select sidelink resources for sidelink communication therebetween. In some examples, a transmitting sidelink device may perform resource/channel sensing to select resources (e.g., sub-channels) on the sidelink channel that are unoccupied. Signaling on the sidelink is the same between the two modes. Therefore, from a receiver's point of view, there is no difference between the modes.

In some examples, sidelink (e.g., PC5) communication may be scheduled by use of sidelink control information (SCI). SCI may include two SCI stages. Stage 1 sidelink control information (first stage SCI) may be referred to herein as SCI-1. Stage 2 sidelink control information (second stage SCI) may be referred to herein as SCI-2.

SCI-1 may be transmitted on a physical sidelink control channel (PSCCH). SCI-1 may include information for resource allocation of a sidelink resource and for decoding of the second stage of sidelink control information (i.e., SCI-2). SCI-1 may further identify a priority level (e.g., Quality of Service (QoS)) of a PSSCH. For example, ultra-reliable-low-latency communication (URLLC) traffic may have a higher priority than text message traffic (e.g., short message service (SMS) traffic). SCI-1 may also include a physical sidelink shared channel (PSSCH) resource assignment and a resource reservation period (if enabled). Additionally, SCI-1 may include a PSSCH demodulation reference signal (DMRS) pattern (if more than one pattern is configured). The DMRS may be used by a receiver for radio channel estimation for demodulation of the associated physical channel. As indicated, SCI-1 may also include information about the SCI-2, for example, SCI-1 may disclose the format of the SCI-2. Here, the format indicates the resource size of SCI-2 (e.g., a number of REs that are allotted for SCI-2), a number of a PSSCH DMRS port(s), and a modulation and coding scheme (MCS) index. In some examples, SCI-1 may use two bits to indicate the SCI-2 format. Thus, in this example, four different SCI-2 formats may be supported. SCI-1 may include other information that is useful for establishing and decoding a PSSCH resource.

SCI-2 may also be transmitted on the PSCCH and may contain information for decoding the PSSCH. According to some aspects, SCI-2 includes a 16-bit layer 1 (L1) destination identifier (ID), an 8-bit L1 source ID, a hybrid automatic repeat request (HARQ) process ID, a new data indicator (NDI), and a redundancy version (RV). For unicast communications, SCI-2 may further include a CSI report trigger. For groupcast communications, SCI-2 may further include a zone identifier and a maximum communication range for NACK. SCI-2 may include other information that is useful for establishing and decoding a PSSCH resource.

In some examples, the SCI (e.g., SCI-1 and/or SCI-2) may further include a resource assignment of retransmission resources reserved for one or more retransmissions of the sidelink transmission (e.g., the sidelink traffic/data). Thus, the SCI may include a respective PSSCH resource reservation and assignment for one or more retransmissions of the PSSCH. For example, the SCI may include a reservation message indicating the PSSCH resource reservation for the initial sidelink transmission (initial PSSCH) and one or more additional PSSCH resource reservations for one or more retransmissions of the PSSCH.

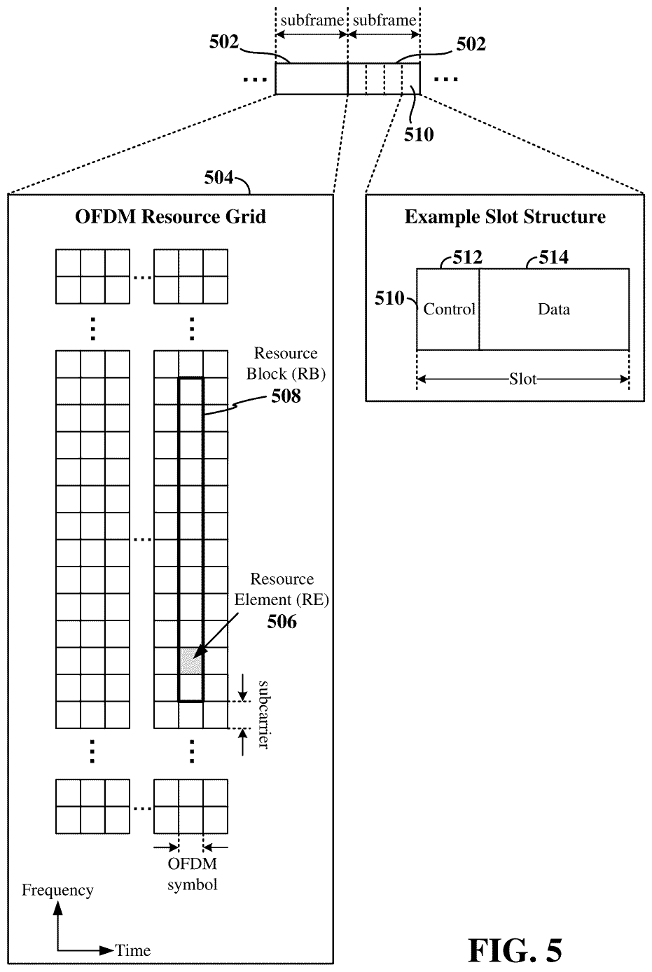

Various aspects of the present disclosure will be described with reference to an OFDM waveform, schematically illustrated in FIG. 5. It should be understood by those of ordinary skill in the art that the various aspects of the present disclosure may be applied to an SC-FDMA waveform in substantially the same way as described hereinbelow. That is, while some examples of the present disclosure may focus on an OFDM link for clarity, it should be understood that the same principles may be applied as well to SC-FDMA waveforms.

Referring now to FIG. 5, an expanded view of an exemplary subframe 502 is illustrated, showing an OFDM resource grid. However, as those skilled in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 504 may be used to schematically represent time-frequency resources for a given antenna port. That is, in a multiple-input-multiple-output (MIMO) implementation with multiple antenna ports available, a corresponding multiple number of resource grids 504 may be available for communication. The resource grid 504 is divided into multiple resource elements (REs) 506. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 508, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain.

A set of continuous or discontinuous resource blocks may be referred to herein as a Resource Block Group (RBG), subband, or bandwidth part (BWP). A set of subbands or BWPs may span the entire bandwidth. Scheduling of wireless communication devices (e.g., V2X devices, sidelink devices, or other UEs, hereinafter generally referred to as UEs) for downlink, uplink, or sidelink transmissions may involve scheduling one or more resource elements 506 within one or more subbands or bandwidth parts (BWPs). Thus, a UE generally utilizes only a subset of the resource grid 504. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a network entity (e.g., an aggregated or disaggregated base station, gNB, eNB, TRP, scheduling entity, etc.) or may be self-scheduled by a UE/sidelink device implementing D2D sidelink communication.

In this illustration, the RB 508 is shown as occupying less than the entire bandwidth of the subframe 502, with some subcarriers illustrated above and below the RB 508. In a given implementation, the subframe 502 may have a bandwidth corresponding to any number of one or more RBs 508. Further, in this illustration, the RB 508 is shown as occupying less than the entire duration of the subframe 502, although this is merely one possible example.

Each 1 ms subframe 502 may consist of one or multiple adjacent slots. In the example shown in FIG. 5, one subframe 502 includes four slots 510, as an illustrative example. In some examples, a slot may be defined according to a specified number of OFDM symbols with a given cyclic prefix (CP) length. For example, a slot may include 7 or 14 OFDM symbols with a nominal CP. Additional example may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of slot 510 illustrates that the slot 510 includes a control region 512 and a data region 514. In general, the control region 512 may carry control channels, and the data region 514 may carry data channels. In some examples, a Uu slot (e.g., slot 510) may contain all DL, all UL, or at least one DL portion and at least one UL portion. The structures illustrated in FIG. 3 are merely exemplary in nature, and different slot structures may be utilized, and may include one or more of each of the control region(s) and data region(s).

Although not illustrated in FIG. 5, the various REs 506 within a RB 508 may be scheduled to carry one or more physical channels, including control channels, shared channels, data channels, etc. Other REs 506 within the RB 508 may also carry pilots or reference signals. These pilots or reference signals may provide for a receiving device to perform channel estimation of the corresponding channel, which may enable coherent demodulation/detection of the control and/or data channels within the RB 508.

In some examples, the slot 510 may be utilized for broadcast, multicast, groupcast, or unicast communication. For example, a broadcast, multicast, or groupcast communication may refer to a point-to-multipoint transmission by one device (e.g., a network entity, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the network entity may allocate one or more REs 506 (e.g., within the control region 512) of the slot 510 to carry DL control information including one or more DL control channels, such as a physical downlink control channel (PDCCH), to one or more UEs (e.g., scheduled entities). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, where the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 506 (e.g., in the control region 512 or the data region 514) of the Uu slot 310 to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 50, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A network entity may transmit other system information (OSI) as well.

In an UL transmission, the UE (e.g., scheduled entity) may utilize one or more REs 506 of the Uu slot 310 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, a measurement report (e.g., a Layer 1 (L1) measurement report), or any other suitable UCI.

In addition to control information, one or more REs 506 (e.g., within the data region 514) of the Uu slot 310 may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 506 within the data region 514 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a PC5 interface, the control region 512 of the slot 510 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 514 of the slot 510 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 506 within slot 510. For example, sidelink MAC-CEs may be transmitted in the data region 314 of the slot 310. In addition, HARQ feedback information may be transmitted in a physical sidelink feedback channel (PSFCH) within the slot 510 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 510.

These physical channels described above are generally multiplexed and mapped to transport channels for handling at the medium access control (MAC) layer. Transport channels carry blocks of information called transport blocks (TB). The transport block size (TBS), which may correspond to a number (e.g., a quantity) of bits of information, may be a controlled parameter based on the modulation and coding scheme (MCS) and the number of RBs in a given transmission.

The channels or carriers described above in connection with FIGS. 1-5 are not necessarily all of the channels or carriers that may be utilized between devices, and those of ordinary skill in the art will recognize that other channels or carriers may be utilized in addition to those illustrated, such as other traffic, control, and feedback channels.

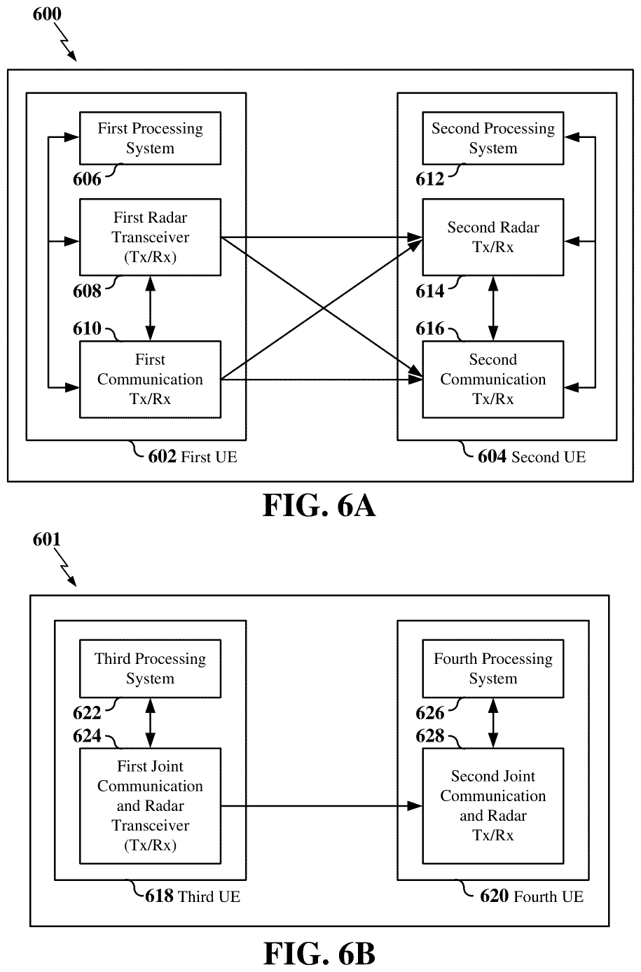

FIGS. 6A and 6B are block diagrams depicting a cooperative joint communication and radio detection and ranging (radar) (JCR) system 600 and a co-designed JCR system 601, respectively, according to some aspects of the disclosure. In the cooperative JCR system 600 of FIG. 6A, a first user equipment (UE) 602, and a second UE 604 are depicted. More than two UEs (not shown) may be included in a cooperative JCR system, such as the cooperative JCR system 600 of FIG. 6A. The first UE 602 includes a first processing system 606, a first radar transceiver 608, and a first communication transceiver 610. As used herein, the word transceiver may be replaced with the abbreviation Tx/Rx. The second UE 604 includes a second processing system 612, a second radar transceiver 614, and a second communication transceiver 616. The first radar transceiver 608 and the first communication transceiver 610 of the first UE 602 may be communicatively coupled to one or more first antennas and/or first antenna arrays (not shown to avoid cluttering the drawing). The second radar transceiver 614 and the second communication transceiver 616 of the second UE 604 may be communicatively coupled to one or more second antennas and/or second antenna arrays (not shown to avoid cluttering the drawing). The first UE 602 and the second UE 604 may be any of the UEs as described and illustrated in connection with FIGS. 1-4, above, for example.

Each of the first processing system 606 and the second processing system 612 may include one or more processors (not shown). Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. The first processing system 606 and the second processing system 612 may be used to respectively control, send data to, receive data from, and otherwise process control signaling and data traffic associated with the first radar transceiver 608 and the first communication transceiver 610, and the second radar transceiver 614 and the second communication transceiver 616, respectively. The first processing system 606 and the second processing system 612 may be respectively used to implement any one or more of the methods, processes, or functions described herein.

In the cooperative JCR system 600, information (e.g., data and/or control signaling) may be shared (e.g., conveyed, transferred) between the first UE 602 and the second UE 604. For example, and as illustrated, the first radar transceiver 608 may share information with at least one of the second radar transceiver 614, or the second communication transceiver 616, and the first communication transceiver 610 may share information with at least one of the second radar transceiver 614, or the second communication transceiver 616. Although illustrated as a unidirectional sharing to reduce clutter in the drawing, it will be understood that the second radar transceiver 614 may share information with at least one of the first radar transceiver 608, or the first communication transceiver 610, and the second communication transceiver 616 may share information with at least one of the first radar transceiver 608, or the first communication transceiver 610. Although information sharing is depicted as occurring directly between the various transceivers, it will be understood that sharing may be implemented via the first processing system 606 and the second processing system 612.

The sharing of information between the various radar transceivers and communication transceivers (or between the first processing system 606 and the second processing system 612) may permit improved performance to be realized at either or both of the first UE 602 and the second UE 604. Improvement in performance due to information sharing may be realized without substantial alteration of core operations of the first radar transceiver 608, the first communication transceiver 610, the second radar transceiver 614, and the second communication transceiver 616 (relative to core operations that may occur in the absence of the information sharing, for example). According to some aspects, the cooperative JCR system 600 may facilitate spectrum reuse. UEs that include a radar transceiver(s) and communication transceiver(s) may be capable of implementing cooperative JCR techniques.

In the co-designed JCR system 601 of FIG. 6B, a third UE 618 and a fourth UE 620 are depicted. More than two UEs (not shown) may be included in a co-designed JCR system, such as the co-designed JCR system 601 of FIG. 6B. The third UE 618 includes a third processing system 622 and a first joint communications and radar transceiver (first JCR transceiver 624). As used herein, the word transceiver may be replaced with the abbreviation Tx/Rx. The fourth UE 620 includes a fourth processing system 626 and a second JCR transceiver 628. The first JCR transceiver 624 and of the third UE 618 may be communicatively coupled to one or more third antennas and/or third antenna arrays (not shown to avoid cluttering the drawing). The second JCR transceiver 628 of the fourth UE 620 may be communicatively coupled to one or more fourth antennas and/or fourth antenna arrays (not shown to avoid cluttering the drawing). The third UE 618 and the fourth UE 620 may be any of the UEs as described and illustrated in connection with FIGS. 1-4, above, for example.

Each of the third processing system 622 and the fourth processing system 626 may include one or more processors (not shown). Examples of processors were described above in connection with the first processing system 606 and the second processing system 612 and will not be repeated for the sake of brevity. The third processing system 622 and the fourth processing system 626 may be used to respectively control, send data to, receive data from, and otherwise process control signaling and data traffic associated with the first JCR transceiver 624, and the second JCR transceiver 628, respectively. The third processing system 622 and the fourth processing system 626 may be respectively used to implement any one or more of the methods, processes, or functions described herein.

In the co-designed JCR system 601, information (e.g., data and/or control signaling) may be shared (e.g., conveyed, transferred) between the third UE 618 and the fourth UE 620. Although illustrated as a unidirectional sharing, from the third UE 618 to the fourth UE 620, to reduce clutter in the drawing, it will be understood that the second JCR transceiver 628 may share information with the first JCR transceiver 624. Although information sharing is depicted as occurring directly between the various transceivers, it will be understood that sharing may be implemented via the third processing system 622 and the fourth processing system 626.

In a co-designed JCR system, such as the co-designed JCR system 601 as shown and described in connection with FIG. 6B, a common transceiver (or in some examples a common transmitter or a common receiver) is used for both radar and communication functionalities. In general, co-designed JCR system may require modification (sometimes significant modification) to either or both of the transmit waveform generation or the receiver processing (in comparison to transmit waveform generation or receiver processing in non-co-designed JCR systems, such as the cooperative JCR system 600 as shown and described in connection with FIG. 6A). According to some aspects, the co-designed JCR system 601 may facilitate spectrum reuse. Additionally, at least because one JCR transceiver may be used instead of one radar transceiver and one communication transceiver, the co-designed JCR system 601 may also facilitate hardware reuse.

In general, cooperative JCR systems (e.g., cooperative JCR system 600) and co-designed JCR systems (e.g., co-designed JCR system 601) may facilitate a common use of radar and communication hardware and functionality (e.g., communication aspects utilized for, or helping with, radar aspects and vice versa). Additionally, both cooperative JCR systems and co-designed JCR systems may facilitate spectrum reuse. Still further, co-designed JCR systems (e.g., co-designed JCR system 601) may facilitate hardware reuse.

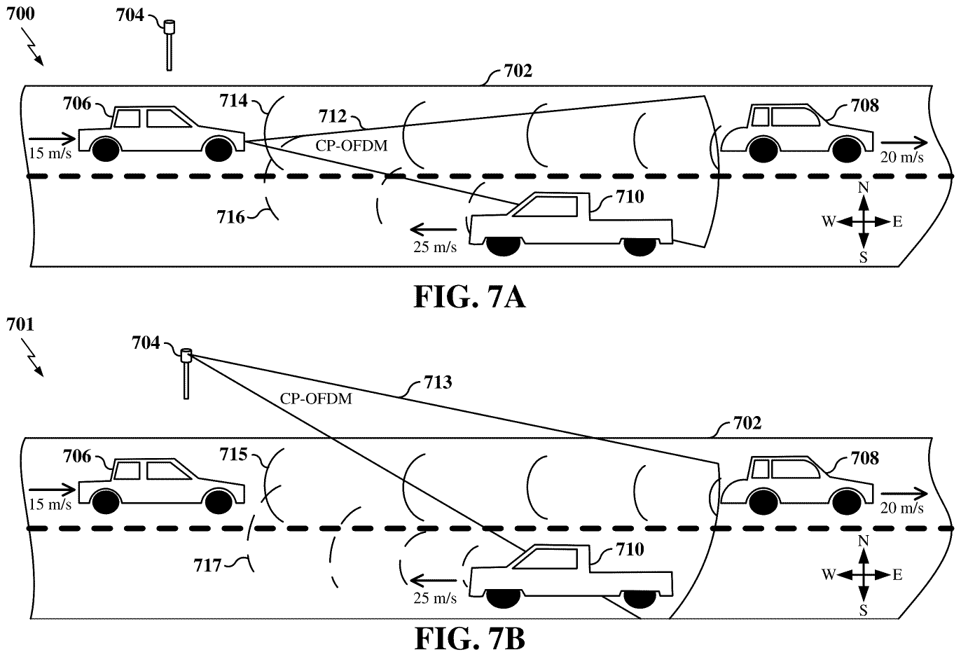

FIGS. 7A and 7B are block diagrams depicting a monostatic radar process/configuration 700 and a bistatic radar process/configuration 701, respectively, according to some aspects of the disclosure. Both FIGS. 7A and 7B depict a roadway 702. The roadway 702, may be any sort of roadway (e.g., path, road, street, avenue, boulevard, highway, etc.) on which one way or two way vehicular (e.g., car, bus, truck, train, motorcycle, bicycle, etc.) traffic flows. The roadway 702 may be a segment of a roadway, for example, a length or segment of a street having cross-roadways (e.g., cross-streets) forming intersections (not shown to avoid cluttering the drawing) at one or both ends of the roadway 702. Both FIGS. 7A and 7B depict a network entity 704. The network entity 704 may be any of the network entities as shown and described in connection with FIGS. 1-4.

The examples of FIG. 7A and FIG. 7B utilize three representative four-wheeled vehicles for ease of illustration and not as a limitation. The first vehicle includes an integrated or otherwise incorporated or co-located UE (e.g., a wireless communication device) (not shown). For ease of reference, the first vehicle is referred to as a first UE 706. The first UE 706 may be any of the UEs as shown and described in connection with FIGS. 1-4 and 6A-6B. The second and third vehicles represent distinct radar targets to the first UE 706. For the examples of FIGS. 7A and 7B, neither of the distinct radar targets necessarily include a respective integrated or otherwise incorporated or co-located UE; that is, for purposes of the examples of FIGS. 7A and 7B, neither of the distinct radar targets must be a UE. However, for convenience of reference, the second vehicle is referred to as a second UE 708, and the third vehicle is referred to as a third UE 710. For the sake of completeness, in an instance where the second UE 708 or the third UE 710 is a UE as described herein, either or both of the second UE 708 or the third UE 710 may be any of the UEs as shown and described in connection with FIGS. 1-4 and 6A-6B.

In both FIGS. 7A and 7B, the first UE 706 is depicted as traveling from west to east at 15 meters/second (m/s). The second UE 708 is in front of (east of) the first UE 706 and in the same lane as the first UE 706. The second UE 708 is depicted as traveling from west to east at 20 m/s. The third UE 710 is in front of (east of) the first UE 706 and in a lane adjacent to the first UE 706. The third UE 710 is heading toward the first UE 706 in the lane adjacent to the first UE 706. The third UE 710 is depicted as traveling from east to west at 25 m/s.

Vehicle UEs, such as the first UE 706, may sense surrounding objects for automotive applications, such as collision avoidance. To enable UE-side JCR sensing (e.g., using a cooperative JCR system 600 as shown and described in connection with FIG. 6A, or a co-designed JCR system 601 as shown and described in connection with FIG. 6B), uplink (UL) resources can be used for UL communication and for radar sensing. According to both the cooperative JCR system 600 as shown and described in connection with FIG. 6A, and the co-designed JCR system 601 as shown and described in connection with FIG. 6B, the UL resources of the first UE 706 may be shared between communication and radar modes. According to one aspect, the same (frequency) UL resources may be used for radar and communication in a scenario in which the first UE 706 utilizes the same (frequency) UL resources in a TDM mode (e.g., utilize a given channel or sub-channel at a first time for radar and at a second, different, time for communication). According to another aspect, the same (time) UL resources may be used for radar and communication in a scenario in which the first UE 706 utilizes the same (time) UL resources in an FDM mode (e.g., utilize a first channel or sub-channel at a given time for radar and a second, different channel or sub-channel at the same given time for communication). According to one example, the UL resources may be scheduled for sounding reference signal (SRS) use and the SRS may be utilized both as a sounding reference signal for communication purposes and as a sensing waveform for radar purposes. As SRS is scheduled across the time domain and the frequency domain, SRS may be used for both communication and radar in a TDM mode and/or in an FDM mode. According to some aspects, the same UL resource may be utilized for radar and communication in a co-designed JCR system (e.g., co-designed JCR system 601 as shown and described in connection with FIG. 6B) using a joint co-designed waveform for both radar and communication purposes.

According to the monostatic radar process/configuration 700 example of FIG. 7A, one antenna (or antenna array) (not shown) at the first UE 706 may be used to transmit the radar signal (and communication signal according to a co-designed JCR system example) and may also be used to receive any of the transmitted radar signal that was reflected from a target back toward the one antenna (or antenna array) at the first UE 706. In some examples, however, there may be two relatively closely spaced antennas (or antenna arrays), where a first of the two antennas (or antenna arrays) may be used to transmit the radar signal and a second of the two antennas (or antenna arrays) may be used to receive any reflection of the radar signal. The use of two relatively closely spaced antennas may be exemplified in a frequency modulated-continuous wave (FM-CW) radar system. If one antenna (or antenna array) is used for both the transmit and receive directions, a duplexer may be utilized to separate the transmit chain from the receive chain. According to the example of FIG. 7A, the waveform 712 for communication and radar purposes may be a cyclic prefix-orthogonal frequency division multiplexing (CP-OFDM) waveform. For example, CP-OFDM (which may utilize variable subcarrier spacing as represented by a numerology referred to herein) may be used as an access technology for 5G New Radio. In some instances, the waveform 712 may be a joint co-designed waveform.

According to the monostatic radar process/configuration 700 example of FIG. 7A, the waveform 712 may be transmitted from the first UE 706 and illuminate the second UE 708 and the third UE 710. Second reflections 714 of the waveform 712 from a surface of the second UE 708, and third reflections 716 of the waveform 712 from a surface of the third UE 710 may be reflected back toward, and received by, the first UE 706. It is noted that uses of the term second reflections 714 in association with the second UE 708, third reflections 716 in association with the third UE 710, etc. are for non-limiting ease of reference purposes only. The received second reflections 714 from the surface of the second UE 708 and third reflections 716 from the surface of the third UE 710 may be processed at the first UE 706 as radar returns. For example, using the third UE 618 as shown and described in connection with FIG. 6B as a non-limiting representative example of the first UE 706 as shown and described in connection with FIGS. 7A and 7B, processing may take place, for example, at the first JCR transceiver 624 and/or the third processing system 622 of the third UE 618. The processed radar returns may inform the first UE 706 of the range, direction, and speed of the second UE 708 and the third UE 710 and may also inform the first UE 706 whether the second UE 708 and third UE 710 are respectively closing (moving toward), receding (moving away), or maintaining (no relative motion) their respective ranges relative to the first UE 706.

According to the bistatic radar process/configuration 701 example of FIG. 7B, a first antenna (or antenna array) at a first device (e.g., the network entity 704) may be used to transmit a radar signal (and/or a communication signal according to a co-designed JCR system example) (e.g., collectively the waveform 713). A second, distant and spaced apart, antenna (or antenna array) at a second device (e.g., the first UE 706) may be used to receive second reflections 715 of the waveform 713 from a surface of the second UE 708, and third reflections 717 of the waveform 713 from a surface of the third UE 710. Both the second reflections 715 and the third reflections 717 may be reflected toward, and received by, the first UE 706. In the bistatic radar example of FIG. 7B, the relative distance and spaced apart nature of the transmit antenna (e.g., the first antenna at the network entity 704) and the receive antenna (e.g., an antenna at the first UE 706) is large in comparison to the distance between separate transmit and receive antennas (two antennas) that may be used in connection with a monostatic radar example of FIG. 7A. In the example of FIG. 7B, similar to the example of FIG. 7A, the received second reflections 715 from the surface of the second UE 708, and third reflections 717 from the surface of the third UE 710 may be processed at the first UE 706 as radar returns. Again, using the third UE 618 as shown and described in connection with FIG. 6B as a non-limiting representative example of the first UE 706 as shown and described in connection with FIGS. 7A and 7B, processing may take place in, for example, the first JCR transceiver 624 and/or the third processing system 622 of the third UE 618. The processed radar returns may inform the first UE 706 of the range, direction, and speed of the second UE 708 and the third UE 710 and may also inform the first UE 706 whether the second UE 708 and third UE 710 are respectively closing (moving toward), receding (moving away), or maintaining (no relative motion) their respective ranges relative to the first UE 706.

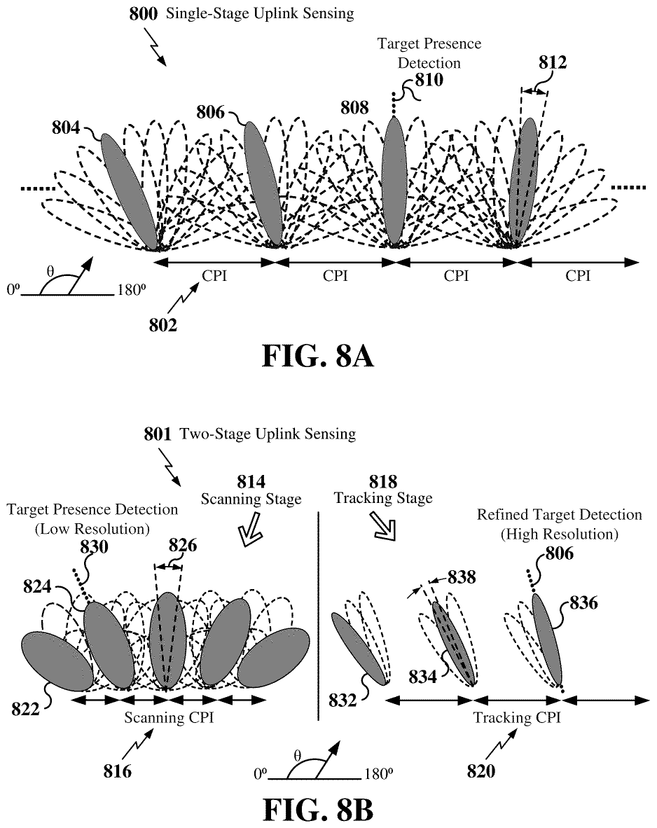

FIGS. 8A and 8B are plots of antenna beam patterns for single-stage uplink (UL) sensing 800 and two-stage UL sensing 801 processes, respectively, according to some aspects of the disclosure. Automobile usage of wireless technology calls for vehicular radar with high resolution. The degree of resolution may be high enough to allow a vehicle with a vehicular radar (e.g., the first UE 706 as shown and described in connection with FIGS. 7A and 7B) to distinguish one vehicular target (or even a pedestrian walking or on a bicycle) from another, for example.

Automobile usage of wireless technology additionally calls for vehicular radar with a high update rate. The degree of the high update rate may be sufficient to facilitate a capability of the vehicle with the vehicular radar to process returns from numerous targets, such as in a case where the vehicle with the vehicular radar is in congested slow moving traffic and/or in tightly spaced traffic moving at nominal or accelerated vehicular speeds.

The degree of the high update rate may be sufficient to permit the vehicle with the vehicular radar to process returns from respective targets that may each have relative motion toward (e.g., targets with closing ranges) or away from (e.g., targets with receding ranges) the vehicle with the vehicular radar. In one example, the update rate may be sufficient to facilitate the vehicle with the vehicular radar in a first lane to process returns (reflections) from a target vehicle, traveling at, or more than, highway speeds (e.g., at about between 25 m/s to 38 m/s) in an adjacent lane in a direction opposite to the direction of travel of the vehicle with the vehicular radar, that unexpectedly changes lanes to the first lane and places the vehicle with the vehicular radar and the target vehicle in a condition of an imminent head-on collision. In such a case, the closing rate of the oncoming target vehicle relative to the vehicle with the vehicular radar (that is also traveling at, or more than, highway speeds) may range from about between 50 m/s (about 112 miles per hour) to about 76 m/s (about 170 miles per hour). In this and other scenarios, the degree of the high update rate (e.g., the value of the update rate) may need to be sufficient to process any threat from any conceivable number of targets in real-time, to give adequate time for the vehicle with the vehicular radar to take evasive action (e.g., apply brakes, change lanes of travel). In addition, high update rates may need to be sufficient to process returns from targets that have sudden changes in their velocity and/or acceleration vectors, such as in a case where a target vehicle in front of the vehicle with vehicular radar slams on its brakes, or changes lanes as exemplified above.

Furthermore, high update rates may need to be sufficient to process returns from targets that change status, for example, from not being a potential threat to being an imminent threat, or targets that newly appear. Examples of the former include a target vehicle in a lane adjacent to the vehicle with the vehicular radar that suddenly changes lanes into the same lane as the vehicle with the vehicular radar. Examples of the latter include, for example, parked vehicles that open a vehicle door into the lane of travel of the vehicle with vehicular radar, or that suddenly leave their parking space and enter the lane of travel of the vehicle with vehicular radar. Additional examples of targets that newly appear may include parked vehicles that suddenly move into traffic, as well as target vehicles that cross the lane in which the vehicle with the vehicular radar is traveling, such as in a case of a target vehicle running a stop sign or a red light at an intersection being approached by the vehicle with the vehicular radar. The preceding lists of situations or scenarios were offered as examples and not intended to limit the scope of the disclosure.

As indicated above, FIG. 8A is a plot of antenna beam patterns for single-stage UL sensing 800 according to some aspects of the disclosure. In one example, an antenna beam pattern (as illustrated in FIG. 8A) for transmission of a waveform emitted from a UE having, for example, a co-designed JCR transceiver (such as the first JCR transceiver 624 of the third UE 618 or the second JCR transceiver 628 of the fourth UE 620 as shown and described in connection with FIG. 6B) may be the same as the antenna beam pattern for the reception of the reflection(s) of that waveform scattered from a given target. In the single-stage UL sensing 800 example, a plurality of antenna beams may provide a desired angular resolution to detect a given target.

In the single-stage UL sensing 800 example of FIG. 8A, a coherent processing interval (CPI) 802 is depicted. The CPI may also be known as a radar frame. At each CPI 802, the direction of the transmit/receive antenna beam changes. During the first CPI, the first angular direction 804 of the antenna beam is about 70 degrees. During the second CPI, the second angular direction 806 of the antenna beam is about 80 degrees. During the third CPI, the third angular direction 808 of the antenna beam is about 90 degrees (e.g., broadside). In this non-limiting example, at the third angular direction 808, the UE detects a first target presence 810. In order to determine the angle of (e.g., the relative bearing of) the first target presence 810 with angular precision sufficient for the UE to distinguish between adjacent targets, for example, the change in angular direction of the beam between each CPI may be relatively small and the beamwidth 812 (e.g., the −3 dB beamwidth) of each beam may be relatively narrow.

By way of an example, and not a limitation, the CPI (per beam) may be equal to 5.1 ms, the bandwidth (BW) may be equal to 0.5 GHz, and the subcarrier spacing (SCS) may be equal to 120 kHz (for Δv=0.4 m/s at f_{c}=73 GHz, ΔR=30 cm). For example, for a 20 frames per second (fps) update rate (which corresponds to a 50 ms sensing period), more than 10 percent of the system resources may be utilized per-beam and per-user. As the example shows, using single-stage UL sensing 800 transmissions may result in a large communication overhead.

In the two-stage UL sensing 801 example of FIG. 8B, a coherent processing interval (CPI) may be changed between the scanning stage 814 (where a scanning CPI 816 may be used) and the tracking stage 818 (where a tracking CPI 820, greater than the scanning CPI 816, may be used). Furthermore, during the scanning stage 814, the angular distance between successive beam-pointing angles can be increased (e.g., compared to the angular distance between successive beam-pointing angles in the single-stage UL sensing 800 example of FIG. 8A). For example, during the first scanning CPI, the first angular direction 822 of the antenna beam is about 35 degrees. During the second scanning CPI, the second angular direction 824 of the antenna beam is about 62 degrees (an angular difference of about 27 degrees). Furthermore, the beamwidth 826 (e.g., the −3 dB beamwidth) of the antenna beam may be widened (compared to the beamwidth 812 of the beam in the single-stage UL sensing 800 example of FIG. 8A).

In the two-stage UL sensing 801 example of FIG. 8B, at the second angular direction 824, the UE detects a second target presence 830 at about 67 degrees. The detection of the second target presence 830 is made with the greater angular difference between angular positions of the antenna beams utilized during the scanning stage 814 (in comparison to the same measure in the single-stage UL sensing 800 example of FIG. 8A) and the wider beamwidth 826 of the antenna beams utilized during the scanning stage 814 (in comparison to that of the single-stage UL sensing 800 example of FIG. 8A). This greater angular difference and wider beamwidth 826 provides a lower resolution (for example, in terms of angular resolution of the location of a target) in comparison to the single-stage UL sensing 800 example of FIG. 8A.

However, in the tracking stage 818 of the two-stage UL sensing 801 example of FIG. 8B, the angular resolution between beam pointing angles at each tracking CPI 820 is less than that utilized during the scanning stage 814. For example, during the first tracking CPI, the first angular direction 832 of the antenna beam is about 54 degrees. During the second tracking CPI, the second angular direction 834 of the antenna beam is about 64 degrees. During the third tracking CPI, the third angular direction 836 of the antenna beam is about 74 degrees. These correspond to about 10 degrees between pointing angles during the tracking stage 818 as compared to about 27 degrees between pointing angles during the scanning stage 814. Furthermore, the beamwidth 838 of the antenna beams during the tracking stage 818 is narrower than the beamwidth 826 of the antenna beams during the scanning stage 814. Thus, in order to determine a refined target detection 840 with angular precision sufficient for the UE to distinguish between adjacent targets, for example, the change in angular direction of the beam between each tracking CPI 820 may be relatively small and the beamwidth 838 (e.g., the −3 dB beamwidth) of each beam may be relatively narrow, both in comparison to the single-stage UL sensing 800 example of FIG. 8A and the scanning stage 814 of the two-stage UL sensing 801 example of FIG. 8B.

For example, and without any intent to limit the scope of the disclosure, during the scanning stage 814, a scanning CPI 816 (per beam) may be equal to 1 ms, a BW may be equal to 150 MHz, and a SCS may be equal to 120 kHz (for Δv=2 m/s, ΔR=1 m). During the tracking stage 818 a tracking CPI 820 (per beam) may be equal to 5 ms, a BW may be equal to 0.5 GHz (500 MHz) with comb-5 decimation in time (1 in every 5th symbol), and comb-4 decimation in frequency (1 every 4th RE). Accordingly, for a 20 frame per second (fps) update rate, 4.5 percent of the system resources per-user and per-detected-target may be utilized. This may be equivalent to a utilization of 9 percent of system resources per-user, assuming there are two targets within a field of view (FoV). Accordingly, two-stage UL sensing (such as that exemplified in the two-stage UL sensing 801 example as shown and described in connection with FIG. 8B), may be used to support multi-radar sensing over shared UL communication resources with low overhead (for example, in comparison to single-stage sensing, such as that exemplified in the single-stage UL sensing 800 example as shown and described in connection with FIG. 8A).

In single-stage sensing, for example as shown and described in connection with FIG. 8A, transmission may be triggered on-demand. On-demand triggering may serve several types of applications. For example, on-demand triggering may be utilized with applications having a limited number of target beam directions to sense. In such an example, on-demand triggering with a limited number of target beam directions may have a relatively low processing overhead (e.g., compared to applications with a greater number of target beam directions to sense). In two-stage sensing, for example as shown and described in connection with FIG. 8B, the parameters for the scanning stage 814 (e.g., in all beam directions, in contrast to a limited number of beam directions described in the single-stage sensing application) and the tracking stage 818 (e.g., in selected beam directions based on a determination of the direction toward one or more targets obtained at the scanning stage) may be different. Additionally, according to some aspects, the scanning stage 814 (also referred to as a scanning phase) may be statically or semi-persistently used for periodic sensing. Key performance indicators that may be associated with the scanning stage 814 include, but are not limited to, large unambiguous velocity estimations, long range radar sensing ability, and wide field of view (which may come at the cost of low angular resolution). The tracking stage 818 (also referred to as the tracking phase) may be semi-persistently or dynamically triggered following the scanning stage 814 (for example, in response to one or more targets being identified at the scanning stage 814). According to some aspects, transmit power control may be supported for bistatic configurations (e.g., for bistatic communication), such as that exemplified in connection with FIG. 7B. In a bistatic configuration, the receiver node (e.g., the first UE 706) is spaced apart from, and is a different node than, a transmitter node (e.g., the network entity 704).

Described herein are techniques associated with the use of a joint communication and radar (JCR) transceiver (such as, for example, the co-designed first JCR transceiver 624 of the third UE 618 or the co-designed second JCR transceiver 628 of the fourth UE 620 as shown and described in connection with FIG. 6B), utilizing a monostatic configuration (e.g., the monostatic radar process/configuration 700 of the first UE 706 (e.g., a vehicle, a vehicle UE, a V-UE) as shown and described in connection with FIG. 7A), in a single-stage or a two-stage monostatic uplink sensing application (such as the single-stage UL sensing 800 or the two-stage UL sensing 801 examples, as shown and described in connection with FIG. 8A or 8B, respectively) according to some aspects of the disclosure. Open and closed-loop uplink power control in the single-stage and/or two-stage monostatic uplink sensing applications may be considered.

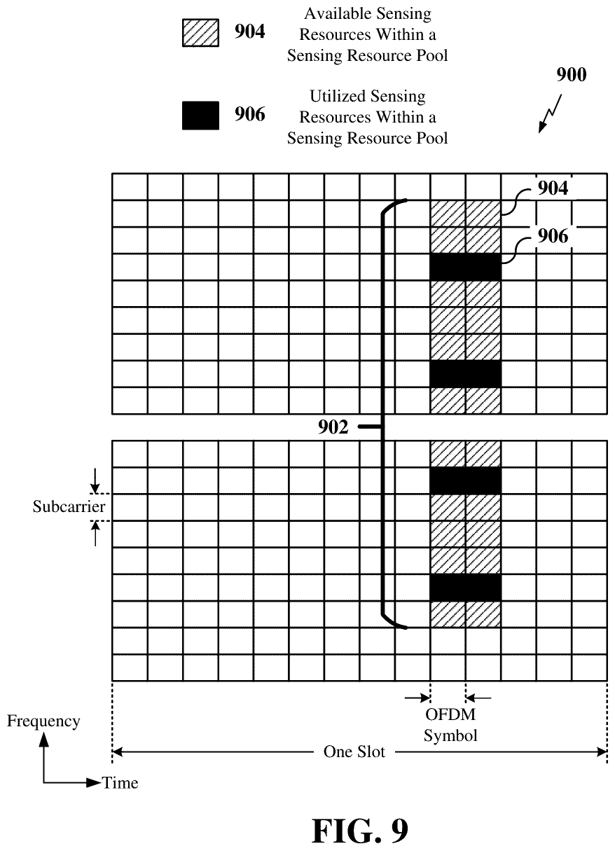

FIG. 9 is a diagram 900 illustrating an example of a sensing resource pool 902 in one slot according to some aspects of the disclosure. The sensing resource pool 902 includes sensing resources. Of those sensing resources, a first plurality are available sensing resource 904, and a second plurality are utilized sensing resources 906. In the non-limiting example of FIG. 9, the utilized sensing resources 906 correspond to sounding reference signal resources; however, other resources (not configured as sounding reference signal resources) are within the scope of the disclosure. In the example of FIG. 9, each utilized sensing resource 906 includes two symbols. In some examples, the number of symbols associated with a sensing resource may differ from two; for example, the number of symbols may be, but are not limited to, 1, 2, or 4. Also, in the example of FIG. 9, every fourth subcarrier is used in connection with the utilized sensing resources 906. In some examples, the pattern of repetition among subcarriers may differ from every fourth subcarrier; for example, the pattern of repetition may be, but is not limited to, every other subcarrier or every fourth subcarrier.

In general, resources in a given slot may be allocated as uplink, downlink, or sidelink resources. According to some aspects, resources allocated for uplink (such as, but not limited to, sounding reference signals) may also be allocated as sensing resources in the sensing resource pool 902. In some examples, a sensing resource pool (such as the sensing resource pool 902) may include contiguous physical resource blocks; however, non-contiguous physical resource blocks are within the scope of the disclosure. Although the example of FIG. 9 depicts a resource pool in one slot, one or more contiguous or non-contiguous slots may be configured as a sensing resource pool. Any given resource (e.g., a symbol) in any given sensing resource pool may correspond to both a sensing resource and an uplink (or, for example, a transmitting sidelink) resource. For example, the uplink waveform (or, for example, the transmitting sidelink waveform) may be used as a sensing waveform. According to some aspects, a sensing resource pool (such as the sensing resource pool 902) may be shared by several UEs for their respective sensing waveform transmissions.

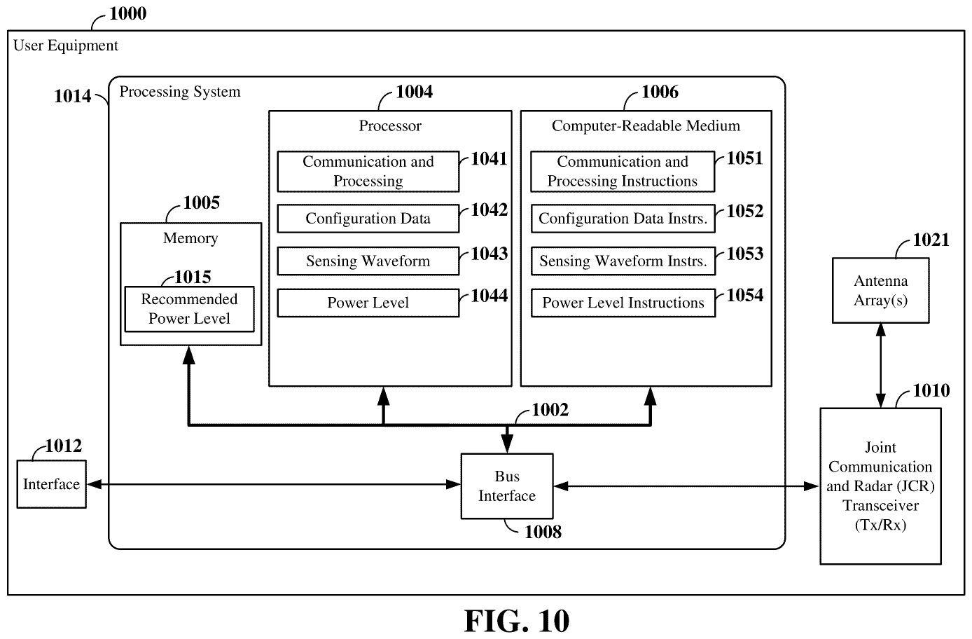

FIG. 10 is a block diagram illustrating an example of a hardware implementation of a user equipment 1000 (e.g., a UE, a wireless communication device, a scheduled entity, a vehicle including an integrated or otherwise incorporated or co-located UE) employing a processing system 1014, according to some aspects of the disclosure. The UE 1000 may be similar to, for example, any of the UEs, receivers, transceivers, scheduled entities, or vehicles, including an integrated or otherwise incorporated or co-located UE of FIGS. 1, 2, 3, 4, 6A, 6B, 7A, and/or 7B.

In accordance with various aspects of the disclosure, an element, any portion of an element, or any combination of elements may be implemented with a processing system 1014 that includes one or more processors, such as processor 1004. Examples of processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1000 may be configured to perform any one or more of the functions described herein. That is, the processor 1004, as utilized in the UE 1000, may be used to implement any one or more of the methods or processes described and illustrated, for example, in FIGS. 6A, 6B, 7A, 7B, 8A, and/or 8B.

In this example, the processing system 1014 may be implemented with a bus architecture, represented generally by the bus 1002. The bus 1002 may include any number of interconnecting buses and bridges depending on the specific application of the processing system 1014 and the overall design constraints. The bus 1002 communicatively couples together various circuits including one or more processors (represented generally by the processor 1004), a memory 1005, and computer-readable media (represented generally by the computer-readable medium 1006). The bus 1002 may also link various other circuits such as timing sources, peripherals, voltage regulators, and power management circuits, which are well known in the art, and therefore, will not be described any further.

A bus interface 1008 provides an interface between the bus 1002 and a joint communication and radar (JCR) transceiver 1010. The JCR transceiver 1010 may be a co-designed JCR transceiver, such as the first JCR transceiver 624 associated with the third UE 618, or the second JCR transceiver 628 associated with the fourth UE 620 as shown and described in connection with FIG. 6B, for example. The JCR transceiver 1010 may be, for example, a wireless transceiver. The JCR transceiver 1010 may provide a means for communicating with various other apparatus over a transmission medium (e.g., air interface), as well as a means for sensing (e.g., utilizing radar) the environment surrounding the UE 1000. The JCR transceiver 1010 may be coupled to one or more antenna arrays 1021. The bus interface 1008 further provides an interface between the bus 1002 and a user interface 1012 (e.g., keypad, display, touch screen, speaker, microphone, control features, etc.). Of course, such a user interface 1012 is optional, and may be omitted in some examples.

One or more processors, such as processor 1004, may be responsible for managing the bus 1002 and general processing, including the execution of software stored on the computer-readable medium 1006. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 1006. The software, when executed by the processor 1004, causes the processing system 1014 to perform the various processes and functions described herein for any particular apparatus.

The computer-readable medium 1006 may be a non-transitory computer-readable medium and may be referred to as a computer-readable storage medium or a non-transitory computer-readable medium. The non-transitory computer-readable medium may store computer-executable code (e.g., processor-executable code). The computer executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1006 may reside in the processing system 1014, external to the processing system 1014, or distributed across multiple entities including the processing system 1014. The computer-readable medium 1006 may be embodied in a computer program product or article of manufacture. By way of example, a computer program product or article of manufacture may include a computer-readable medium in packaging materials. In some examples, the computer-readable medium 1006 may be part of the memory 1005. Those skilled in the art will recognize how best to implement the described functionality presented throughout this disclosure depending on the particular application and the overall design constraints imposed on the overall system. The computer-readable medium 1006 and/or the memory 1005 may also be used for storing data that is manipulated by the processor 1004 when executing software.

In some aspects of the disclosure, the processor 1004 may include communication and processing circuitry 1041 configured for various functions, including for example communicating with a network entity (e.g., an aggregated or disaggregated base station, gNB, eNB, TRP, scheduling entity, etc.), a network core (e.g., a 5G core network), and another wireless communication device (e.g., a UE, a scheduled entity), or any other entity, such as, for example, local infrastructure or an entity communicating with the UE 1000 via the Internet, such as a network provider. The communication and processing circuitry 1041 may also be configured for various functions, including for example, managing processes associated with radar functionality of the UE 1000. In some examples, the communication and processing circuitry 1041 may include one or more hardware components that provide the physical structure that performs processes related to wireless communication (e.g., signal reception and/or signal transmission), signal processing (e.g., processing a received signal and/or processing a signal for transmission), and/or radar associated processing (e.g., causing transmission of JCR waveform in uplink (UL) resources and processing of the JCR waveform reflected from targets back toward the UE 1000 and received by the antenna array(s) 1021 of the UE 1000). In some examples, the communication and processing circuitry 1041 may be configured to transmit a report to a network entity, the report identifying prospective transmissions from other UEs that will interfere with receiving a reflection of a sensing waveform transmitted from the UE 1000 and reflected back toward the UE 1000 from the target. According to some examples, the UE 1000 may transmit the report to cause the network entity to reduce transmitter power of the other UEs during the prospective transmissions. The communication and processing circuitry 1041 may further be configured to execute communication and processing instructions 1051 (e.g., software) stored on the computer-readable medium 1006 to implement one or more functions, including but not limited to communication and radar functions, described herein.

In some aspects of the disclosure, the processor 1004 may include configuration data circuitry 1042 configured for various functions. The functions of the configuration data circuitry 1042 may include, for example, receiving configuration data, including an indication of at least one of: sensing resources, or a sensing resource pool. In some examples, resources defined by the indication of the at least one of: the sensing resources, or the sensing resource pool may be associated with uplink resources. In some examples, the at least one of: the sensing resources, or the sensing resource pool may be associated with at least one of: a minimum power value of a starting power value associated with the transmitting of the sensing waveform, a step size utilized to change a power value associated with the transmitting of the sensing waveform, or a maximum power value associated with the transmitting of the sensing waveform. According to some aspects, the step size may be utilized to change the power value associated with the transmitting of the sensing waveform by an integer multiple of the step size. In some aspects, content of the sensing resource pool may be defined based on an application of the sensing. For example, the application may be directed to at least one of: short-range scanning, or long-range scanning, the short-range scanning being associated with a first range to the target and the long-range scanning being associated with a second range to the target, the first range being less than the second range. Additionally, the short-range scanning may be associated with a first update rate and a first default power value that is faster and less than, respectively, a second update rate and a second default power value associated with the long-range scanning, and the long-range scanning may be associated with the second update rate and the second default power value that is slower and greater than, respectively, the first update rate and the first default power value associated with the short-range scanning. The configuration data circuitry 1042 may further be configured to execute configuration data instructions 1052 (e.g., software) stored on the computer-readable medium 1006 to implement one or more functions described herein.

In some aspects of the disclosure, the processor 1004 may include sensing waveform circuitry 1043 configured for various functions, including, for example, transmitting a sensing waveform configured according to the at least one of: the sensing resources, or the sensing resource pool. In some examples, the sensing waveform may be transmitted in a plurality of directions, a recommended (e.g., selected, determined, obtained) power level (e.g., a power level that may be utilized to transmit a sensing waveform from the JCR transceiver 1010) may be a plurality of recommended power levels, and each respective one of the plurality of recommended power levels corresponds to one of the plurality of directions. One or more recommended power levels may be stored, for example, in a recommended power level 1015 location of the memory 1005. According to some aspects, the sensing waveform may be a sounding reference signal (SRS). According to some aspects, the sensing waveform may be at least one of: a control signal, or a data message. In some examples, the transmitting the sensing waveform configured according to the at least one of: the sensing resources, or the sensing resource pool, further includes, and the sensing waveform circuitry 1043 may be further configured to cause: scanning with a first transmitter power every M periods followed by scanning with a second transmitter power every N periods, where the first transmitter power is greater than the second transmitter power, M and N are positive integers, and M is less than N. In some examples, at least one of M or N is transmitted from the UE 1000 to a network entity (such as any of the network entities as shown and described in connection with FIGS. 1, 2, 3, 4, 7A, and/or 7B) or configured to the UE 1000 by the network entity. The sensing waveform circuitry 1043 may further be configured to execute sensing waveform instructions 1053 (e.g., software) stored on the computer-readable medium 1006 to implement one or more functions described herein.

In some aspects of the disclosure, the processor 1004 may include power level circuitry 1044 configured for various functions, including, for example, transmitting a recommended power level based on a reflection of the sensing waveform received at the UE 1000 from a target. For example, the UE 1000 may sense a surrounding area (a surrounding environment in any given direction relative to the UE 1000) in a monostatic mode. The UE 1000 may receive reflections from targets, where the reflections are reflections of the sensing waveform scattered from the targets and received at the JCR transceiver 1010 via the antenna array(s) 1021. In the example of the monostatic radar process/configuration 700 as shown and described in connection with FIG. 7A, the UE 1000 may be represented by the first UE 706, and examples of targets may include the second UE 708 and the third UE 710. According to some aspects, the recommended power level may be associated with at least one of: a scanning stage, or a tracking stage of a two-stage uplink sensing process (such as, for example, the scanning stage 814, or the tracking stage 818, respectively, of the two-stage UL sensing 801 process example as shown and described in connection with FIG. 8B). According to some examples, the recommended power level may increase as a distance between the UE 1000 and the target increases. In some examples, the recommended power level may be a function of a radar cross section of the target, and the recommended power level may decrease as the radar cross section of the target increases. In some examples, the recommended power level may be reported as at least one of: a discrete power value, or a difference between a predetermined power value and the discrete power value. In some examples, the predetermined power value may be a maximum power defined in association with the at least one of: the sensing resources, or the sensing resource pool. In some examples, an initial scanning may utilize a first power level greater than a minimum power level, and in response to detecting fewer first targets having first respective signal to interference plus noise ratio (SINR) values that are less than a threshold SINR value, than second targets having second respective SINR values that are greater than or equal to the threshold SINR value, a subsequent scanning may utilize a second power level, less than the first power level. In some examples, the second power level may be utilized in the subsequent scanning for M periods (e.g., where M is a positive integer). In some examples, at least one of the threshold SINR value, or M is pre-configured to the UE 1000.

In some examples, the UE 1000 (that is, the communication and processing circuitry 1041 and/or the power level circuitry 1044, for example, via the JCR transceiver 1010 and antenna array(s) 1021) may receive an adjustment to the recommended power level that is based on a measure of congestion (e.g., a quantified value representative of the congestion) realized in a network associated with the UE 1000. The adjustment to the recommended power level may be provided by, and the amount of congestion may be determined by, a network entity, for example. The UE 1000 (e.g., the communication and processing circuitry 1041 and/or the power level circuitry 1044) may transmit the sensing waveform based on the adjustment to the recommended power level. By way of example and not limitation, in a network such as a congested network, in response to the adjustment corresponding to an increase over the recommended power level, the UE 1000 may be configured to transmit the sensing waveform according to the increase over the recommended power level and at a reduced update rate to detect long-range targets and reduce congestion, respectively, and in response to the adjustment corresponding to decrease below the recommended power level, the UE may be configured to transmit the sensing waveform according to the decrease below the recommended power level to decrease a quantity of targets detected within the congested network.

According to some aspects, at least one of the communication and processing circuitry 1041, or the power level circuitry may further be configured to transmit at least one of the threshold SINR value, or M to a network entity. According to some aspects, any one or more of the communication and processing circuitry 1041, the configuration data circuitry 1042, the sensing waveform circuitry 1043, and the power level circuitry 1044 may be further configured to transmit an update to the at least one of: the sensing resources, or the sensing resource pool, the update including a recommended starting power for an upcoming transmission of the sensing waveform. The power level circuitry 1044 may further be configured to execute power level instructions 1054 (e.g., software) stored on the computer-readable medium 1006 to implement one or more functions described herein.

According to some aspects, the transmitting of the sensing waveform from the UE 1000 and receiving the reflection of the sensing waveform at the UE 1000 from a target (both by, for example, the sensing waveform circuitry 1043 in conjunction with the JCR transceiver 1010 and the antenna array(s) 1021) may be performed according to a monostatic radar process.

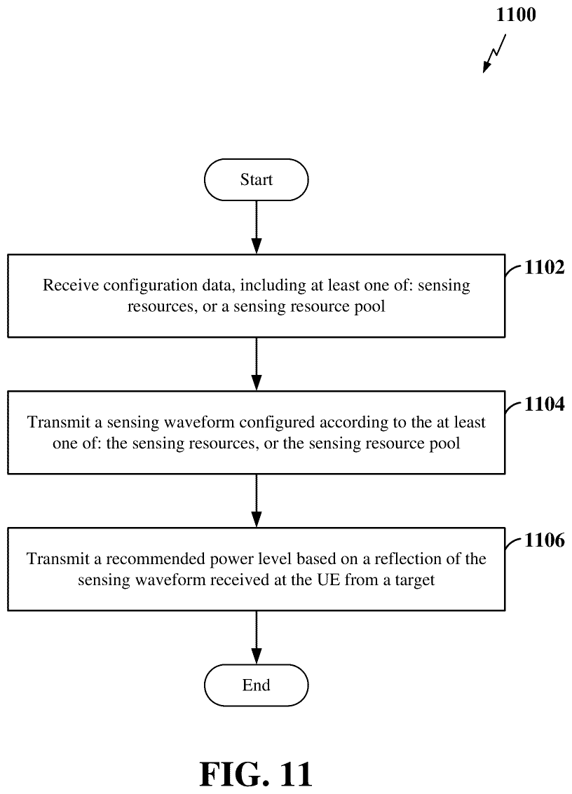

FIG. 11 is a flow chart illustrating an example process 1100 (e.g., a method) at a user equipment (UE), according to some aspects of the disclosure. The process 1100 may be associated with wireless communication and radar in a wireless communication network. As described below, some or all illustrated features may be omitted in a particular implementation within the scope of the present disclosure, and some illustrated features may not be required for implementation of all examples. In some examples, the process 1100 may be carried out by the UE 1000 as illustrated and described in connection with FIG. 10. The UE 1000 may be similar to, for example, any of the UEs, receivers, transceivers, scheduled entities, or vehicles including an integrated or otherwise incorporated or co-located UE of FIGS. 1, 2, 3, 4, 6A, 6B, 7A, and/or 7B. In some examples, the process 1100 may be carried out by any suitable apparatus or means for carrying out the functions or algorithm described below.

At block 1102, the UE may receive configuration data, including at least one of: sensing resources, or a sensing resource pool. For example, the configuration data circuitry 1042 in conjunction with the JCR transceiver 1010 and the antenna array(s) 1021 as shown and described above in connection with FIG. 10, may provide a means to receive configuration data, including at least one of: sensing resources, or a sensing resource pool. In some examples, resources defined by the at least one of: the sensing resources, or the sensing resource pool may be associated with uplink resources. According to some aspects, the at least one of: the sensing resources, or the sensing resource pool, may be associated with at least one of: a minimum power value of a starting power value associated with the transmitting of the sensing waveform, a step size utilized to change a power value associated with the transmitting of the sensing waveform, or a maximum power value associated with the transmitting of the sensing waveform. In some examples, the step size may be utilized to change the power value associated with transmitting the sensing waveform by an integer multiple of the step size. According to some aspects, the content of the sensing resource pool may be defined based on an application of the sensing. For example, the application may be directed to at least one of: short-range scanning, or long-range scanning, the short-range scanning being associated with a first range to the target and the long-range scanning being associated with a second range to the target, the first range being less than the second range. According to the example, the short-range scanning may be associated with a first update rate and a first default power value that is faster and less than a second update rate and a second default power value associated with the long-range scanning. According to the example, the long-range scanning may be associated with the second update rate and the second default power value that is slower and greater than, respectively, the first update rate and the first default power value associated with the short-range scanning.

At block 1104, the UE may transmit a sensing waveform configured according to the at least one of: the sensing resources, or the sensing resource pool. For example, the sensing waveform circuitry 1043 in conjunction with the JCR transceiver 1010 and the antenna array(s) 1021 as shown and described above in connection with FIG. 10 may provide a means to transmit a sensing waveform configured according to the at least one of: the sensing resources, or the sensing resource pool. According to some aspects, the sensing waveform may be transmitted in a plurality of directions, the recommended power level may be a plurality of recommended power levels, and each respective one of the plurality of recommended power levels may correspond to one of the plurality of directions. According to one aspect, the sensing waveform may be a sounding reference signal (SRS). According to one aspect, the sensing waveform may be at least one of: a control signal, or a data message. In one example, the transmitting the sensing waveform configured according to the at least one of: the sensing resources, or the sensing resource pool, may further include scanning with a first transmitter power every M periods followed by scanning with a second transmitter power every N periods, where the first transmitter power is greater than the second transmitter power, M and N are positive integers, and M is less than N. In some examples, at least one of M, or N are transmitted from the UE to a network entity or configured to the UE by the network entity.

At block 1106, the UE may transmit a recommended (e.g., selected, determined, obtained) power level based on a reflection of the sensing waveform received at the UE from a target. For example, the power level circuitry 1044 in conjunction with the JCR transceiver 1010 and the antenna array(s) 1021, as shown and described above in connection with FIG. 10, may provide a means to transmit a recommended power level based on a reflection of the sensing waveform received at the UE from a target. In one example, the recommended power level may be associated with at least one of: a scanning stage, or a tracking stage of a two-stage uplink sensing process, such as the two-stage UL sensing 801 process as shown and described in connection with FIG. 8B. In some examples, the recommended power level may increase as the distance between the UE and the target increases. In some examples, the recommended power level may be a function of a radar cross section of the target, and the recommended power level may decrease as the radar cross section of the target increases. According to some aspects, the recommended power level may be reported as at least one of: a discrete power value, or a difference between a predetermined power value and the discrete power value. In one example, the predetermined power value may be a maximum power defined in the at least one of: the sensing resources, or the sensing resource pool.

According to some aspects an initial scanning utilizes a first power level greater than a minimum power level, and in response to detecting fewer first targets having first respective signal to interference plus noise ratio (SINR) values that are less than a threshold SINR value, than second targets having second respective SINR values that are greater than or equal to the threshold SINR value, a subsequent scanning utilizes a second power level, less than the first power level. In some examples, the second power level is utilized in the subsequent scanning for M periods. In some examples, at least one of the threshold SINR value, or M may be pre-configured to the UE. In some examples, the UE may further transmit at least one of the threshold SINR value, or M to a network entity. For example, the communication and processing circuitry 1041 and/or the power level circuitry 1044, in conjunction with the JCR transceiver 1010 and the antenna array(s) 1021, may provide a means to further transmit at least one of the threshold SINR value, or M to a network entity.

According to some aspects, the UE may further transmit an update to the at least one of: the sensing resources, or the sensing resource pool, the update including a recommended starting power for an upcoming transmission of the sensing waveform. For example, the communication and processing circuitry 1041, the configuration data circuitry 1042, and/or the power level circuitry 1044, in conjunction with the JCR transceiver 1010 and the antenna array(s) 1021, may provide a means to further transmit an update to the at least one of: the sensing resources, or the sensing resource pool, the update including a recommended starting power for an upcoming transmission of the sensing waveform.

According to some aspects, the UE may further transmit a report to a network entity, the report identifying prospective transmissions from other UEs that will interfere with receiving the reflection of the sensing waveform from the target. In some examples, the UE may transmit the report to cause the network entity to reduce transmitter power of the other UEs during the prospective transmissions. For example, the communication and processing circuitry 1041, in conjunction with the JCR transceiver 1010 and the antenna array(s) 102, may provide a means to further transmit a report to a network entity, the report identifying prospective transmissions from other UEs that will interfere with receiving the reflection of the sensing waveform from the target.

According to some aspects, the UE may further receive an adjustment to the recommended power level that is based a measure of congestion (e.g., a quantified value representative of the congestion) realized in a network associated with the UE, and the UE may still further transmit the sensing waveform based on the adjustment to the recommended power level. In examples of a network, including a congested network, in response to the adjustment corresponding to an increase over the recommended power level, the UE may be configured to transmit the sensing waveform according to the increase over the recommended power level and at a reduced update rate to detect long-range targets and reduce congestion, respectively. In examples of a network, including a congested network, in response to the adjustment corresponding to decrease below the recommended power level, the UE may be configured to transmit the sensing waveform according to the decrease below the recommended power level to decrease a quantity of targets detected within the congested network. For example, the communication and processing circuitry 1041 and/or the sensing waveform circuitry 1043, in conjunction with the JCR transceiver 1010 and the antenna array(s) 1021, may provide a means to receive an adjustment to the recommended power level that is based on a measure of congestion realized in a network associated with the UE, and may also provide a means to transmit the sensing waveform based on the adjustment to the recommended power level.

According to some aspects, the transmitting of the sensing waveform from the UE and receiving the reflection of the sensing waveform at the UE from a target may be performed according to a monostatic radar process.

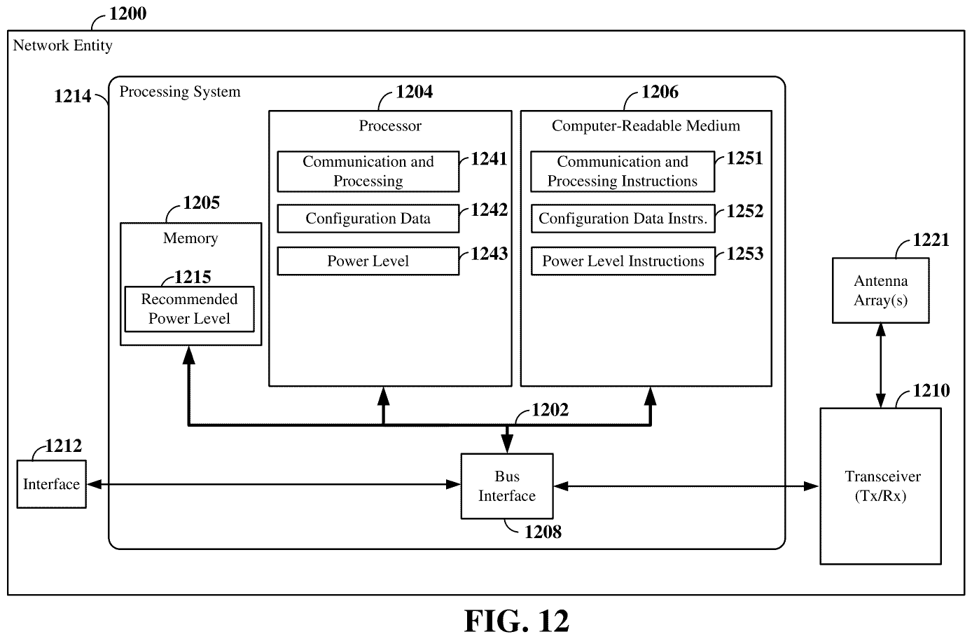

FIG. 12 is a block diagram illustrating an example of a hardware implementation of a network entity 1200 (e.g., an aggregated or disaggregated base station, gNB, eNB, TRP, scheduling entity, etc.) employing a processing system 1214, according to some aspects of the disclosure. The network entity 1200 may be similar to, for example, any of the network entities of FIGS. 1, 2, 3, 4, 7A, and/or 7B.

The processing system 1214 may be substantially the same as the processing system 1014 illustrated in FIG. 10, including a bus interface 1208, a bus 1202, a memory 1205, a processor 1204, and a computer-readable medium 1206. In accordance with various aspects of the disclosure, an element, or any portion of an element, or any combination of elements may be implemented with a processing system 1214 that includes one or more processors, such as processor 1204. Furthermore, the network entity 1200 may include a user interface 1212, a transceiver 1210, and one or more antenna array(s) 1221 substantially similar to those described above in connection with FIG. 10. The transceiver 1210 may be, for example, a wireless transceiver. The processor 1204, as utilized in a network entity 1200, may be used to implement any one or more of the processes described herein and illustrated, for example, in FIGS. 1, 2, 3, 4, 6A, 6B, 7A, and/or 7B.

In some aspects of the disclosure, the processor 1204 may include communication and processing circuitry 1241 configured for various functions, including for example communicating with a user equipment (UE), a network core (e.g., a 5G core network), and another network entity (e.g., an aggregated or disaggregated base station, gNB, eNB, TRP, scheduling entity, etc.), or any other entity, such as, for example, local infrastructure or an entity communicating with the network entity 1200 via the Internet, such as a network provider. In some examples, the communication and processing circuitry 1241 may include one or more hardware components that provide the physical structure that performs processes related to wireless communication (e.g., signal reception and/or signal transmission) and signal processing (e.g., processing a received signal and/or processing a signal for transmission). According to some aspects, the communication and processing circuitry 1241 may be configured for other various functions, including, for example, receiving a report from a first UE, the report identifying prospective transmissions from other UEs that will interfere with receiving the reflection of the sensing waveform from a target at the first UE. The communication and processing circuitry 1241 and/or the power level circuitry 1243 may further be configured to configure the other UEs to reduce their respective transmitter power during the prospective transmissions. In some examples, the communication and processing circuitry 1241 and/or the power level circuitry 1243 may be further configured to obtain (e.g., determine, select) a measure of congestion of a network associated with the first UE, and transmit an adjustment to the recommended power level that is based on the measure of congestion. The communication and processing circuitry 1241 may further be configured to execute communication and processing instructions 1251 (e.g., software) stored on the computer-readable medium 1206 to implement one or more functions described herein.

In some aspects of the disclosure, the processor 1204 may include configuration data circuitry 1242 configured for various functions. The functions of the configuration data circuitry 1242 may include, for example, transmitting (e.g., to a UE) configuration data, including at least one of: sensing resources, or a sensing resource pool. According to some aspects, resources defined by the at least one of: the sensing resources, or the sensing resource pool may be associated with uplink resources. According to some aspects, the sensing resource pool may be defined based on an application of the sensing. In some examples the application may be directed to at least one of: short-range scanning, or long-range scanning, the short-range scanning being associated with a first range to the target and the long-range scanning being associated with a second range to the target, the first range being less than the second range. In the examples, the short-range scanning may be associated with a first update rate and a first default power value that is faster and less than, respectively, a second update rate and a second default power value associated with the long-range scanning, and the long-range scanning may be associated with the second update rate and the second default power value that is slower and greater than, respectively, the first update rate and the first default power value associated with the short-range scanning. According to some aspects, the network entity 1200, via the configuration data circuitry 1242, for example, may be further configured to receive an update to the at least one of: the sensing resources, or the sensing resource pool, the update including a recommended starting power for an upcoming transmission of the sensing waveform. The configuration data circuitry 1242 may further be configured to execute configuration data instructions 1252 (e.g., software) stored on the computer-readable medium 1206 to implement one or more functions described herein.

In some aspects of the disclosure, the processor 1204 may include power level circuitry 1243 configured for various functions. The functions of the power level circuitry 1243 may include, for example, receiving a recommended power level based on a reflection of a sensing waveform received at a user equipment (UE). The recommended power level received at the network entity 1200 may be received from the UE. The reflection may be reflected from a surface of a target toward the UE. In some examples, the recommended power level may be associated with at least one of: a scanning stage, or a tracking stage of a two-stage uplink sensing process, such as the two-stage UL sensing 801 process as shown and described in connection with FIG. 8B, for example. In some examples, the sensing waveform may be associated with a monostatic radar process, such as the monostatic radar process/configuration 700 as shown and described in connection with FIG. 7A, for example. In some examples, the sensing waveform may be a sounding reference signal (SRS). According to some aspects, in response to the sensing waveform may be configured according to the at least one of: the sensing resources, or the sensing resource pool, and power level circuitry 1243 may further be configured to configure a UE to scan with a first transmitter power every M periods followed by scanning with a second transmitter power every N periods, where the first transmitter power is greater than the second transmitter power, M and N are integers, M is less than N, and at least one of M, or N are configured to the UE by the network entity. The power level circuitry 1243 may further be configured to execute power level instructions 1253 (e.g., software) stored on the computer-readable medium 1206 to implement one or more functions described herein.

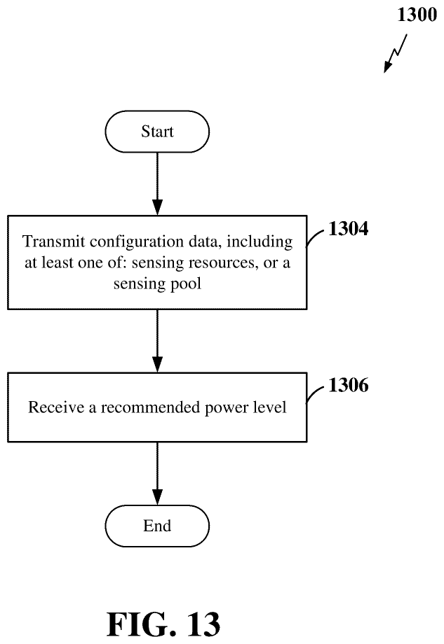

FIG. 13 is a flow chart illustrating an example process 1300 (e.g., a method) at a network entity, according to some aspects of the disclosure. The process 1300 may be associated with wireless communication and/or radar (or joint communication and radar) in a wireless communication network. As described below, some or all illustrated features may be omitted in a particular implementation within the scope of the present disclosure, and some illustrated features may not be required for the implementation of all examples. In some examples, the process 1300 may be carried out by the network entity 1200 as illustrated and described in connection with FIG. 12. The network entity 1200 may be similar to, for example, any of the network entities of FIGS. 1, 2, 3, 4, 7A, and/or 7B. In some examples, the process 1300 may be carried out by any suitable apparatus or means for carrying out the functions or algorithm described below.

At block 1302, the network entity may transmit configuration data, including at least one of: sensing resources, or a sensing resource pool. The transmission may be sent to a first user equipment (UE), such as any of the UEs as shown and described in connection with FIGS. 1, 2, 3, 4, 6A, 6B, 7A, and/or 7B, for example. For example, the configuration data circuitry 1142, as shown and described in connection with FIG. 12, may provide a means to transmit configuration data, including at least one of: sensing resources, or a sensing resource pool (to the first UE). According to some aspects, resources defined by the at least one of: the sensing resources, or the sensing resource pool may be associated with uplink resources. According to some aspects, the sensing resource pool may be defined based on an application of the sensing. In some examples the application may be directed to at least one of: short-range scanning, or long-range scanning, the short-range scanning being associated with a first range to the target and the long-range scanning being associated with a second range to the target, the first range being less than the second range. In the examples, the short-range scanning may be associated with a first update rate and a first default power value that is faster and less than, respectively, a second update rate and a second default power value associated with the long-range scanning, and the long-range scanning may be associated with the second update rate and the second default power value that is slower and greater than, respectively, the first update rate and the first default power value associated with the short-range scanning. According to some aspects, the network entity may be further configured to receive an update to the at least one of: the sensing resources, or the sensing resource pool, the update including a recommended starting power for an upcoming transmission of the sensing waveform. For example, the configuration data circuitry 1242, as shown and described in connection with FIG. 12, may provide a means to receive an update to the at least one of: the sensing resources, or the sensing resource pool, the update including a recommended starting power for an upcoming transmission of the sensing waveform.

At block 1304, the network entity may receive a recommended power level. The recommended power level may be recommended (e.g., selected, determined, obtained) by the first UE. The recommended power level may be based on a reflection of a sensing waveform received at the first UE. The sensing waveform may be transmitted by the first UE during a transmitting period, and, during a sensing period, the first UE may receive the reflection of the sensing waveform, which may have been reflected toward the first UE from a target. For example, the power level circuitry 1243, as shown and described in connection with FIG. 12, may provide a means to receive a recommended power level (e.g., from the first UE). In some examples, the recommended power level may be associated with at least one of: a scanning stage, or a tracking stage of a two-stage uplink sensing process, such as the two-stage UL sensing 801 process as shown and described in connection with FIG. 8B, for example. The recommended power level may be sorted in a recommended power level storage location 1215 of the memory 1205, for example. In some examples, the sensing waveform may be associated with a monostatic radar process, such as the monostatic radar process/configuration 700 as shown and described in connection with FIG. 7A, for example. In some examples, the sensing waveform may be a sounding reference signal (SRS). According to some aspects, in response to the sensing waveform may be configured according to the at least one of: the sensing resources, or the sensing resource pool, and power level circuitry 1243 may further be configured to configure a UE to scan with a first transmitter power every M periods followed by scanning with a second transmitter power every N periods, where the first transmitter power is greater than the second transmitter power, M and N are integers, M is less than N, and at least one of M, or N are configured to the UE by the network entity.

According to some aspects, the network entity 1200 may further be configured to receive a report from a first UE, the report identifying prospective transmissions from other UEs that will interfere with receiving the reflection of a sensing waveform from a target at the first UE. According to other aspects, the network entity 1200 may be further configured to configure the other UEs to reduce their respective transmitter power during the prospective transmissions. In some examples, the network entity 1200 may further be configured to obtain (e.g., determine, select) a measure of congestion of a network associated with the first UE, and transmit (e.g., to the first UE) an adjustment to the recommended power level that is based on the measure of congestion. By way of example, the communication and processing circuitry 1241, configuration data circuitry 1242, and/or the power level circuitry 1243 may provide a means to receive a report from a first UE, the report identifying prospective transmissions from other UEs that will interfere with receiving the reflection of a sensing waveform from a target at the first UE, configure the other UEs to reduce their respective transmitter power during the prospective transmissions, obtain a measure of congestion of a network associated with the first UE, and/or transmit an adjustment to the recommended power level that is based on the measure of congestion.

Of course, in the above examples, the circuitry included in the processor 1004 of FIG. 10 and/or the processor 1204 of FIG. 12 are merely provided as examples. Other means for carrying out the described processes or functions may be included within various aspects of the present disclosure, including but not limited to the instructions stored in the computer-readable medium 1006 of FIG. 10 and/or the computer-readable medium 1206 of FIG. 12, or any other suitable apparatus or means described in any one of the FIGS. 1, 2, 3, 4, 6A, 6B, 7A, 7B, 10, and/or 12 and utilizing, for example, the processes and/or algorithms described herein in relation to FIGS. 16A, 6B, 7A, 7B, 8A, 8A, 11, and or 13.

The following provides an overview of aspects of the present disclosure:

Aspect 1: A user equipment (UE), comprising: a transceiver; a memory; and a processor coupled to the transceiver and the memory, the processor being configured to: receive configuration data, including at least one of: sensing resources, or a sensing resource pool, transmit a sensing waveform configured according to the at least one of: the sensing resources, or the sensing resource pool, and transmit a recommended power level based on a reflection of the sensing waveform received at the UE from a target.

Aspect 2: The UE of Aspect 1, wherein the processor is further configured to receive the reflection of the sensing waveform at the UE from the target, and the transmit the sensing waveform and the receive the reflection of the sensing waveform are performed according to a monostatic radar process.

Aspect 3: The UE of Aspect 1 or 2, wherein resources defined by the at least one of: the sensing resources, or the sensing resource pool are associated with uplink resources.

Aspect 4: The UE of any of Aspects 1 through 3, wherein content of the sensing resource pool is defined based on an application of the sensing.

Aspect 5: The UE of Aspect 4, wherein: the application is directed to at least one of: short-range scanning, or long-range scanning, the short-range scanning being associated with a first range to the target and the long-range scanning being associated with a second range to the target, the first range being less than the second range, the short-range scanning is associated with a first update rate and a first default power value that is faster and less than, respectively, a second update rate and a second default power value associated with the long-range scanning, and the long-range scanning is associated with the second update rate and the second default power value that is slower and greater than, respectively, the first update rate and the first default power value associated with the short-range scanning.

Aspect 6: The UE of any of Aspects 1 through 5, wherein the sensing waveform is a sounding reference signal (SRS).

Aspect 7: The UE of any of Aspects 1 through 6, wherein the recommended power level is associated with at least one of: a scanning stage, or a tracking stage of a two-stage uplink sensing process.

Aspect 8: The UE of any of Aspects 1 through 7, wherein the processor is further configured to: transmit an update to the at least one of: the sensing resources, or the sensing resource pool, the update including a recommended starting power for an upcoming transmission of the sensing waveform.

Aspect 9: The UE of any of Aspects 1 through 8, wherein the processor is further configured to: transmit a report to a network entity, the report identifying prospective transmissions from other UEs that will interfere with receiving the reflection of the sensing waveform from the target.

Aspect 10: The UE of any of Aspects 1 through 9, wherein the processor is further configured to: receive an adjustment to the recommended power level that is based on a measure of congestion realized in a network associated with the UE, and transmit the sensing waveform based on the adjustment to the recommended power level.

Aspect 11: A method at a user equipment (UE), comprising: receiving configuration data, including at least one of: sensing resources, or a sensing resource pool; transmitting a sensing waveform configured according to the at least one of: the sensing resources, or the sensing resource pool; and transmitting a recommended power level based on a reflection of the sensing waveform received at the UE from a target.

Aspect 12: The method of Aspect 11, further comprising: receiving the reflection of the sensing waveform at the UE from the target, wherein the transmitting the sensing waveform from the UE and the receiving the reflection of the sensing waveform at the UE from the target are performed according to a monostatic radar process.

Aspect 13: The method of Aspect 11 or 12, wherein resources defined by the at least one of: the sensing resources, or the sensing resource pool are associated with uplink resources.

Aspect 14: The method of any of Aspects 11 through 13, wherein content of the sensing resource pool is defined based on an application of the sensing.

Aspect 15: The method of Aspect 14, wherein: the application is directed to at least one of: short-range scanning, or long-range scanning, the short-range scanning being associated with a first range to the target and the long-range scanning being associated with a second range to the target, the first range being less than the second range, the short-range scanning is associated with a first update rate and a first default power value that is faster and less than, respectively, a second update rate and a second default power value associated with the long-range scanning, and the long-range scanning is associated with the second update rate and the second default power value that is slower and greater than, respectively, the first update rate and the first default power value associated with the short-range scanning.

Aspect 16: The method of any of Aspects 11 through 15, wherein the sensing waveform is a sounding reference signal (SRS).

Aspect 17: The method of any of Aspects 11 through 16, wherein the recommended power level is associated with at least one of: a scanning stage, or a tracking stage of a two-stage uplink sensing process.

Aspect 18: The method of any of Aspects 11 through 17, further comprising: transmitting an update to the at least one of: the sensing resources, or the sensing resource pool, the update including a recommended starting power for an upcoming transmission of the sensing waveform.

Aspect 19: The method of any of Aspects 11 through 18, further comprising: transmitting a report to a network entity, the report identifying prospective transmissions from other UEs that will interfere with receiving the reflection of the sensing waveform from the target.

Aspect 20: The method of any of Aspects 11 through 19, further comprising: receiving an adjustment to the recommended power level that is based on a measure of congestion realized in a network associated with the UE; and transmitting the sensing waveform based on the adjustment to the recommended power level.

Aspect 21: A network entity, comprising: a memory; and a processor coupled to the memory, the processor being configured to: transmit configuration data, including at least one of: sensing resources, or a sensing resource pool; and receive a recommended power level based on a reflection of a sensing waveform received at a user equipment (UE) from a target.

Aspect 22: The network entity of Aspect 21, wherein the sensing waveform is associated with a monostatic radar process.

Aspect 23: The network entity of Aspect 21 or 22, wherein resources defined by the at least one of: the sensing resources, or the sensing resource pool are associated with uplink resources.

Aspect 24: The network entity of any of Aspects 21 through 23, wherein the recommended power level is associated with at least one of: a scanning stage, or a tracking stage of a two-stage uplink sensing process.

Aspect 25: The network entity of any of Aspects 21 through 24, wherein the processor is further configured to: receive an update to the at least one of: the sensing resources, or the sensing resource pool, the update including a recommended starting power for an upcoming transmission of the sensing waveform.

Aspect 26: A method at a network entity, comprising: transmitting configuration data, including at least one of: sensing resources, or a sensing resource pool; and receiving a recommended power level based on a reflection of a sensing waveform received at a user equipment (UE) from a target.

Aspect 27: The method of Aspect 26, wherein the sensing waveform is associated with a monostatic radar process.

Aspect 28: The method of Aspect 26 or 27, wherein resources defined by the at least one of: the sensing resources, or the sensing resource pool are associated with uplink resources.

Aspect 29: The method of any of Aspects 26 through 28, wherein the recommended power level is associated with at least one of: a scanning stage, or a tracking stage of a two-stage uplink sensing process.

Aspect 30: The method of any of Aspects 26 through 29, further comprising: receiving an update to the at least one of: the sensing resources, or the sensing resource pool, the update including a recommended starting power for an upcoming transmission of the sensing waveform.

Aspect 31: An apparatus configured for wireless communication comprising at least one means for performing a method of any of aspects 11 through 20 or 26 through 30.

Aspect 32: A non-transitory computer-readable medium storing computer-executable code, comprising code for causing an apparatus to perform a method of any of aspects 11 through 20 or 26 through 30.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-13 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-13 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein. While some examples illustrated herein depict only time and frequency domains, additional domains such as a spatial domain are also contemplated in this disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. The construct “A and/or B” is intended to cover: A; B; and A and B. The word “obtain” as used herein may mean, for example, acquire, calculate, construct, derive, determine, receive, and/or retrieve. The preceding list is exemplary and not limiting. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

1. A user equipment (UE), comprising:
a transceiver;
a memory; and
a processor coupled to the transceiver and the memory, the processor being configured to:
receive configuration data, including at least one of: sensing resources, or a sensing resource pool,
transmit a sensing waveform configured according to the at least one of: the sensing resources, or the sensing resource pool, and
transmit a recommended power level based on a reflection of the sensing waveform received at the UE from a target.

2. The UE of claim 1, wherein the processor is further configured to receive the reflection of the sensing waveform at the UE from the target, and the transmit the sensing waveform and the receive the reflection of the sensing waveform are performed according to a monostatic radar process.

3. The UE of claim 1, wherein resources defined by the at least one of: the sensing resources, or the sensing resource pool are associated with uplink resources.

4. The UE of claim 1, wherein content of the sensing resource pool is defined based on an application of the sensing.

5. The UE of claim 4, wherein:
the application is directed to at least one of: short-range scanning, or long-range scanning, the short-range scanning being associated with a first range to the target and the long-range scanning being associated with a second range to the target, the first range being less than the second range,
the short-range scanning is associated with a first update rate and a first default power value that is faster and less than, respectively, a second update rate and a second default power value associated with the long-range scanning, and
the long-range scanning is associated with the second update rate and the second default power value that is slower and greater than, respectively, the first update rate and the first default power value associated with the short-range scanning.

6. The UE of claim 1, wherein the sensing waveform is a sounding reference signal (SRS).

7. The UE of claim 1, wherein the recommended power level is associated with at least one of: a scanning stage, or a tracking stage of a two-stage uplink sensing process.

8. The UE of claim 1, wherein the processor is further configured to:
transmit an update to the at least one of: the sensing resources, or the sensing resource pool, the update including a recommended starting power for an upcoming transmission of the sensing waveform.

9. The UE of claim 1, wherein the processor is further configured to:
transmit a report to a network entity, the report identifying prospective transmissions from other UEs that will interfere with receiving the reflection of the sensing waveform from the target.

10. The UE of claim 1, wherein the processor is further configured to:
receive an adjustment to the recommended power level that is based on a measure of congestion realized in a network associated with the UE, and transmit the sensing waveform based on the adjustment to the recommended power level.

11. A method at a user equipment (UE), comprising:
receiving configuration data, including at least one of: sensing resources, or a sensing resource pool;
transmitting a sensing waveform configured according to the at least one of: the sensing resources, or the sensing resource pool; and
transmitting a recommended power level based on a reflection of the sensing waveform received at the UE from a target.

12. The method of claim 11, further comprising:
receiving the reflection of the sensing waveform at the UE from the target, wherein the transmitting the sensing waveform from the UE and the receiving the reflection of the sensing waveform at the UE from the target are performed according to a monostatic radar process.

13. The method of claim 11, wherein resources defined by the at least one of: the sensing resources, or the sensing resource pool are associated with uplink resources.

14. The method of claim 11, wherein content of the sensing resource pool is defined based on an application of the sensing.

15. The method of claim 14, wherein:
the application is directed to at least one of: short-range scanning, or long-range scanning, the short-range scanning being associated with a first range to the target and the long-range scanning being associated with a second range to the target, the first range being less than the second range,
the short-range scanning is associated with a first update rate and a first default power value that is faster and less than, respectively, a second update rate and a second default power value associated with the long-range scanning, and
the long-range scanning is associated with the second update rate and the second default power value that is slower and greater than, respectively, the first update rate and the first default power value associated with the short-range scanning.

16-20. (canceled)

21. A network entity, comprising:
a memory; and
a processor coupled to the memory, the processor being configured to:
transmit configuration data, including at least one of: sensing resources, or a sensing resource pool; and
receive a recommended power level based on a reflection of a sensing waveform received at a user equipment (UE) from a target.

22. The network entity of claim 21, wherein the sensing waveform is associated with a monostatic radar process.

23. The network entity of claim 21, wherein resources defined by the at least one of: the sensing resources, or the sensing resource pool are associated with uplink resources.

24. The network entity of claim 21, wherein the recommended power level is associated with at least one of: a scanning stage, or a tracking stage of a two-stage uplink sensing process.

25. The network entity of claim 21, wherein the processor is further configured to: receive an update to the at least one of: the sensing resources, or the sensing resource pool, the update including a recommended starting power for an upcoming transmission of the sensing waveform.

26-30. (canceled)
